(19) United States
(12) Patent Application Publication
(10) Pub. No.: US 2025/0348191 A1
(43) Pub. Date: Nov. 13, 2025

(54) GENERATING AN IMAGE FROM A PROMPT CONSTRUCTED USING A PROMPT GUIDING INTERFACE

(71) Applicant: Apple Inc., Cupertino, CA (US)

(72) Inventors: Alexandre Carlhian, Paris (FR); Alexandre R Moha, Los Altos, CA (US); Vignesh Jagadeesh, Saratoga, CA (US); Ohil K Manyam, Seattle, WA (US)

(21) Appl. No.: 18/903,706

(22) Filed: Oct. 1, 2024

Related U.S. Application Data
(60) Provisional application No. 63/645,432, filed on May 10, 2024.

(51) Int. Cl. G06F 3/0482; G06F 3/0484; G06F 40/40; G06T 3/40; G06T 11/00

(52) U.S. Cl. CPC G06F 3/0482; G06F 3/0484; G06T 3/40; G06T 11/00; G06F 40/40; G06T 2200/24

(57) ABSTRACT

The present technology pertains to an on-device media-generation service. Since the media-generation service runs entirely on user's device, the user's privacy is preserved and they can be comfortable interacting with their sensitive data. The present technology also makes the media-generation service simple to use and achieve desired results. The present technology provides a prompt-guiding interface that makes suggestions and guides users toward the selection of descriptive prompts that are more likely to achieve a consistently good result. The prompt-guiding interface is further combined with a fast operation that can generate multiple candidate previews from which a user can select a desired output. This gives users quick feedback on the quality of their prompt and allows users to easily edit their prompts to see updated previews.

### CROSS-REFERENCE TO RELATED APPLICATIONS

This application claims the benefit of priority to U.S. provisional application No. 63/645,432, filed on May 10, 2024, which is expressly incorporated by reference herein in its entirety.

### BACKGROUND

The evolution of media-generation services in the computational and artificial intelligence fields has led to significant advancements in data synthesis and manipulation. Among these, diffusion models have emerged as a powerful class of generative models known for their ability to generate high-quality, diverse samples across various domains such as images, audio, and text. Media-generation services commonly can receive prompts (in modalities such as text and/or images) and can generate content responsive to the prompts.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example system in accordance with some embodiments of the present technology.

FIG. 2 illustrates an example system in accordance with some embodiments of the present technology.

FIG. 3 illustrates an example of visual-media generation application operating on a device in accordance with some embodiments of the present technology.

FIG. 4A and FIG. 4B illustrates an example routine for generating an image using a media-generation service from a prompt constructed using a prompt-guiding interface of a visual-media generation application.

FIG. 5 illustrates a graphical user interface of a visual-media generation application showing a prompt-guiding interface for selecting an image to be included as part of a prompt in accordance with some embodiments of the present technology.

FIG. 6A and FIG. 6B illustrates a graphical user interface of a visual-media generation application showing a prompt-guiding interface receiving text input as part of a prompt in accordance with some embodiments of the present technology.

FIG. 7A, FIG. 7B, and FIG. 7C illustrates a graphical user interface of a visual-media generation application showing a prompt-guiding interface presenting style as suggested prompt concepts in accordance with some embodiments of the present technology.

FIG. 8 illustrates a graphical user interface of a visual-media generation application showing categories of suggested prompt concepts presented in a prompt-guiding interface in accordance with some embodiments of the present technology.

FIG. 9 illustrates an example routine for generating visual media content using the media-generation service in accordance with some embodiments of the present technology.

FIG. 10 illustrates an example routine for training a media-generation service with a filtered dataset of candidate images in accordance with some embodiments of the present technology.

FIG. 11 illustrates an example routine for training the media-generation service to produce images, including faces with improved detail, especially when generating thumbnail images in accordance with some embodiments of the present technology.

FIG. 12 illustrates an example routine for performing human feedback and reinforcement learning using synthetic prompts in accordance with some embodiments of the present technology.

FIG. 13A illustrates a method of calling an application programing interface (API) to obtain information in accordance with some embodiments of the present technology.

FIG. 13B illustrates a method of calling an API to obtain information and performing an operation related to the obtained information in accordance with some embodiments of the present technology.

FIG. 13C illustrates an device including an application that includes instructions for use in calling an API in accordance with some embodiments of the present technology.

FIG. 13D illustrates a system including an API for responding to API calls in accordance with some embodiments of the present technology.

FIG. 13E illustrates API calling instructions 1380, which is part of an application, communicating with an API that is part of a system in accordance with some embodiments of the present technology.

FIG. 13F illustrates a system of calling an API to obtain information in accordance with some embodiments of the present technology.

FIG. 14 illustrates an example method for receiving suggested prompt concepts from a suggested prompt concept service in accordance with some embodiments of the present technology.

FIG. 15 illustrates an example method for receiving a request to provide, and providing, suggested prompt concepts from a visual-media generation application in accordance with some embodiments of the present technology.

FIG. 16 illustrates an example method for requesting the generation of visual media content in accordance with some embodiments of the present technology.

FIG. 17 illustrates an example method for receiving a request to generate visual media content based on a prompt and steps associated with replying to the request in accordance with some embodiments of the present technology.

FIG. 18 is a system diagram illustrating a device in accordance with some embodiments of the present technology.

FIG. 19 illustrates an example of a deep learning neural network that can be used to implement a perception module and/or one or more validation modules, according to some aspects of the disclosed technology.

FIG. 20 illustrates an aspect of the subject matter in accordance with one embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Artificial intelligence (AI) tools have generated a lot of interest in recent months, however, the use of these tools can still be intimidating. For example, although a casual user of a computing device might know of the generative capabilities of some artificial intelligence tools, the casual user generally does not know what can be input into a generative artificial intelligence tool and what can reasonably expected to be output by the generative artificial intelligence tool. Even less casual users are likely to know what a diffusion model or large language model is or how it works. Accordingly, there is a need in the art to make generative artificial intelligence tools more approachable to users, both casual and advanced users.

Furthermore, generative artificial intelligence tools can be associated with safety concerns, such as when a generative artificial intelligence tool might generate content that is not age-appropriate or content that is considered offensive or dangerous. Accordingly, there is a need in the art for generative artificial intelligence tools with multiple safety layers.

One anticipated use case for generative artificial intelligence tools is to receive photos from a user's photo library as part of a prompt to create a modified image, place a subject of the photo in another setting, or make other modifications. However, photos include private content, and as such, it is not desirable to send user's photos over the Internet to a cloud-based resource. Generative artificial intelligence tools are most commonly located in cloud data centers because most of these generative artificial intelligence tools are very large and require significant use of graphic processing units (GPUs) to generate content in an acceptable period. Accordingly, there is a need to give users access to generative artificial intelligence tools while keeping their photos private.

The present technology addresses all of these concerns.

In particular, the present technology pertains to an on-device media-generation service. In some embodiments, the media-generation service is an algorithm for generating media such as images or videos from prompts. In some embodiments, the media-generation service is a generative artificial intelligence tool. Since the media-generation service runs entirely on user's device, the user's privacy is preserved and they can be comfortable interacting with their sensitive data.

The creation of an on-device generative AI service that can produce high-quality images was a significant challenge. The on-device generative AI service was subject to several training optimizations to allow the model to be small enough (few enough trainable parameters) to run on-device while being large enough (enough trainable parameters) to produce high-quality output. As described herein, the generative AI service was trained specifically on images that the generative AI service is likely to receive as prompts, among other training innovations addressed herein. Other engineering optimizations were also conceived to limit memory usage.

The present technology also addresses safety concerns through multiple approaches. The generative AI service was selectively trained on a filtered dataset to avoid training on content that might itself be objectionable. The present technology prohibits prompts that appear to be requesting content in violation of a content policy. And, to ensure that the generative AI service does not generate offensive or dangerous content, notwithstanding the other safeguards, the outputs of the generative AI service can be characterized to ensure that offensive or dangerous content is not delivered to the user.

The present technology also makes generative artificial intelligence tools simple to use and achieve desired results. While some generative artificial intelligence tools allow for a natural language interface, these interfaces are deceivingly complex. While these interfaces look simple to use because users can provide prompts in a natural language input, it turns out that users are generally not descriptive enough in their prompts, and therefore, users do not achieve consistently good results from generative artificial intelligence tools that accept natural language inputs. The present technology addresses this shortcoming of generative artificial intelligence tools by providing a prompt-guiding interface that makes suggestions and guides users toward the selection of descriptive prompts that are more likely to achieve a consistently good result.

The prompt-guiding interface is further combined with a fast operation that can generate multiple candidate previews from which a user can select a desired output. This gives users quick feedback on the quality of their prompt and allows the users to easily edit their prompts to see updated previews.

Collectively, the present technology results in an easy to use media-generation service that is designed from initial model training through creation of content at inference time with safety and privacy as priorities.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of person al information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

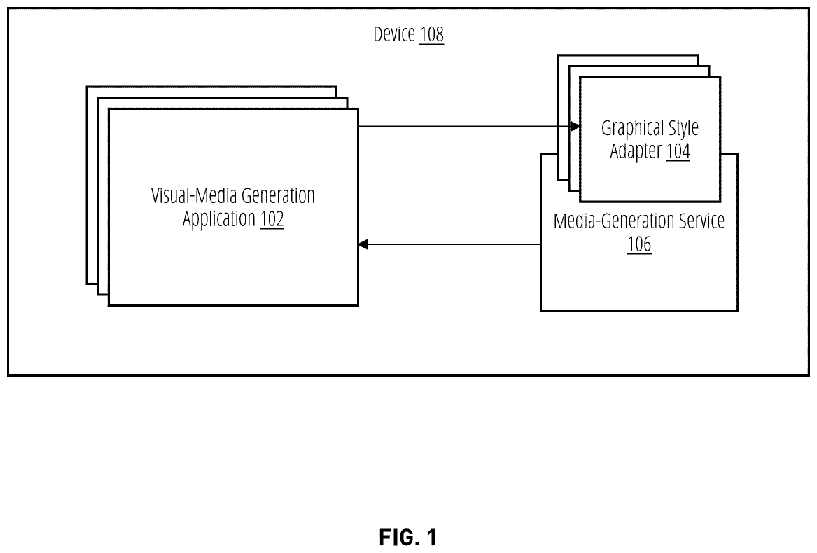

FIG. 1 illustrates an example system in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

As introduced above, the present technology attempts to provide a media-generation service to run locally on a computing device. The present technology utilizes a common media-generation service for a variety of use cases and supplements the common media-generation service with a variety of graphical style adapters. As illustrated in FIG. 1, the present technology includes one or more visual-media generation applications 102 interacting with a common media-generation service 106 through one or more graphical style adapters 104. In some embodiments, the visual-media generation application 102 can interact with the graphical style adapter 104 and media-generation service 106 via calling one or more application programming interfaces (APIs).

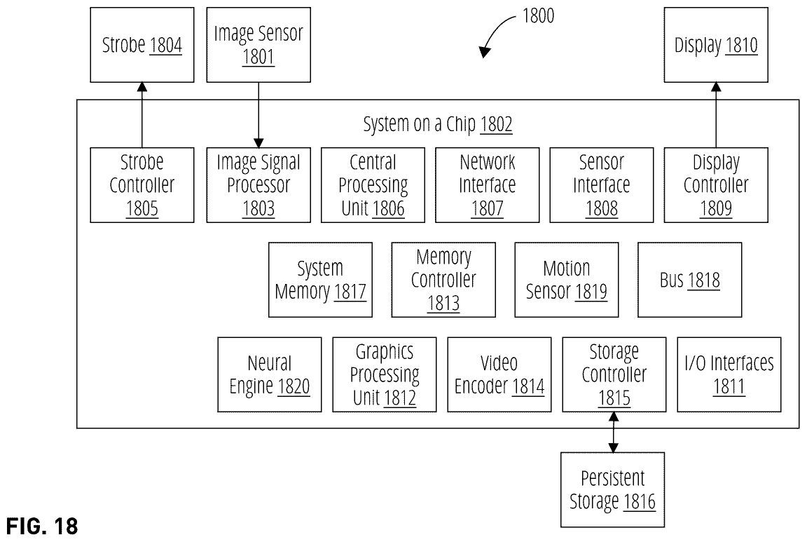

It is preferred that most functions of visual-media generation applications 102 are performed on a local computing device, or at a minimum, functions of visual-media generation applications 102 that occur over a networked connection are functions that are limited in scope and are configured to occur in a privacy-preserving manner. For example, some embodiments of the present technology utilize networked resources, but photos from a user's photo library are not transmitted over a network and are maintained on device 108. The graphical style adapter 104 and media-generation service 106 can be executed by one or more processing components of system on a chip 1802 illustrated in FIG. 18. In particular, neural engine 1820 can be optimized for executing machine learning and artificial intelligence algorithms such as graphical style adapter 104 and media-generation service 106. Graphics processing unit 1812, illustrated in FIG. 18, is also well suited for executing media-generation service 106 and graphical style adapter 104.

To enable the media-generation service 106 to provide the required quality while allowing the size of the common media-generation service to be small enough to run locally on device 108—even when a mobile computing device—the present technology utilizes graphical style adapters 104. Graphical style adapters 104 are configured to perform one or more functions to adapt media-generation service 106 to be more versatile while permitting the media-generation service 106 to be small enough to run on device 108. In some embodiments, graphical style adapters 104 are configured to enable media-generation service 106 to output different styles of images. In some embodiments, graphical style adapters 104 are configured to preprocess data into suitable inputs to media-generation service 106 to result in high-quality output.

In some embodiments, the media-generation service 106 refers to artificial intelligence algorithms and models capable of creating or generating new content, data, or solutions based on learned patterns and data structures. Media-generation service 106 is used in various applications ranging from natural language processing to image and video generation. The present technology generally utilizes media-generation service 106 for use in creating images. Some types of media-generation service models that can be suitable for visual media content generation include one or more of:
Generative Adversarial Networks (GANs) which are a class of AI algorithms where two neural networks, the generator and the discriminator, are trained simultaneously. The generator learns to produce content (such as images) that is increasingly indistinguishable from real data, while the discriminator learns to differentiate between real and generated content. GANs are particularly effective in generating realistic images, enhancing image quality, or converting one image type into another (e.g., sketches to photographs).
Variational Autoencoders (variational auto-encoders) which are generative models that use the principles of Bayesian inference to generate new data points. variational auto-encoders are effective in generating images, performing image enhancement, and more, by learning to encode data into a lower-dimensional space and then decoding it back, potentially with modifications.
Diffusion Models which are generative models that work by gradually adding and then reversing noise to/from data or images to create new instances or transform existing ones. This model simulates a diffusion process, which is mathematically akin to the physical process of particles moving from areas of higher concentration to lower concentration, but applies it in the data or image space. In its application, especially in fields such as artificial intelligence, computer vision, and machine learning, a diffusion model iteratively refines data or images by initially introducing randomness and then stepwise removing it across a series of stages to either create new data instances or enhance existing ones. This process allows for the generation of highly realistic images, the enhancement of signal quality in noisy data, or even the creation of complex data structures. These models have shown remarkable results in generating high-quality, detailed images and in tasks such as image-to-image translation, super-resolution, and content creation with nuanced control over the generation process.
Transformers for Image Generation. Transformers are designed for natural language processing and have been adapted for generative tasks in the image domain through models like Vision Transformers (ViTs). These models can generate images by learning spatial hierarchies and relationships between different parts of an image, making them useful for generating complex scenes or detailed images from textual descriptions.

The present technology can utilize one or more of the media-generation service models referred to above. In some embodiments, the media-generation service models referred to above may be part of media-generation service 106 or part of graphical style adapters 104.

Adapters refer to specialized layers inserted into pre-trained media-generation service models to fine-tune them for specific tasks without the need to comprehensively retrain the entire network. These adapters allow for the efficient adaptation of a model to new domains or tasks by only training the parameters of the adapter layers, rather than the entire model, thereby saving significant computational resources and time. Adapters are particularly useful in scenarios where a generative AI model, initially trained on a broad dataset, needs to be customized for generating content in a specialized field or style. The architecture of an adapter typically involves a small neural network inserted between the layers of the original model. During the adaptation process, the weights of the original model are frozen, and only the weights of the adapter layers are updated based on the new target data or task. This method maintains the general knowledge the model has learned during its initial training while empowering it with the ability to generate or process data in ways tailored to specific requirements. Adapters offer a powerful method for leveraging the capabilities of large, general-purpose generative AI models across a wide range of applications, enabling customization and flexibility while minimizing the need for extensive retraining or the development of entirely new models from scratch.

The graphical style adapters 104 illustrated in FIG. 1 adapt the media-generation service 106 to generate content, particularly images, in a particular style. The graphical style adapters 104 can also be used to transform diverse inputs to be better suited for use with the media-generation service 106.

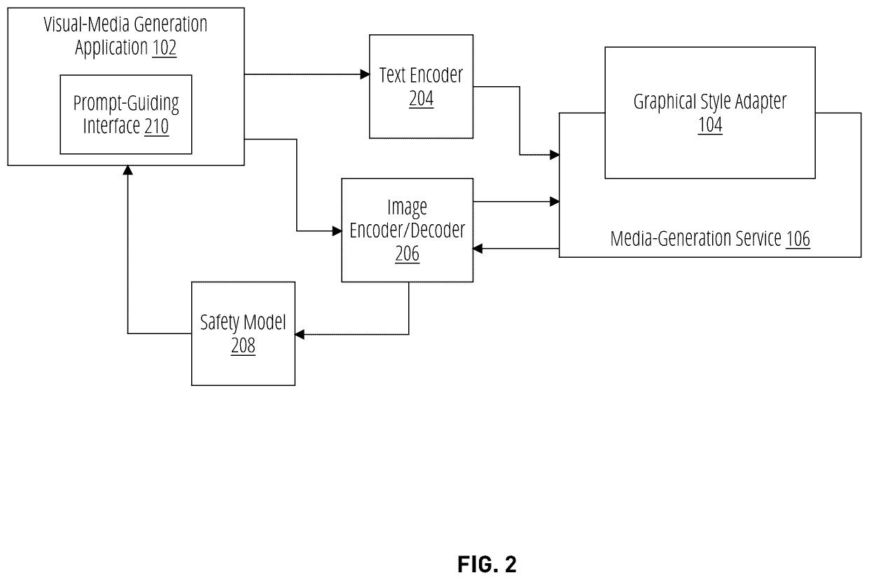

FIG. 2 illustrates an example system in accordance with some embodiments of the present technology. In particular, FIG. 2 illustrates additional detail not shown in FIG. 1, where at least some of the additional detail is relevant to a particular implementation of the system shown in FIG. 1. Descriptions addressed with respect to FIG. 1 should be considered relevant to the system illustrated in FIG. 2 as well. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 2 pertains to an embodiment of the system illustrated in FIG. 1 in which visual-media generation application 102 is capable of receiving a prompt to generate an image. Visual-media generation application 102 is configured to aid a user in generating a prompt to cause a media-generation service to generate visual media content. While most often, the generated visual media content is expected to be based on an image of a person or an animal that is modified based on a prompt, the image of a person or an animal is not a prerequisite, and the user can use visual-media generation application 102 to generate visual media content from textual prompts alone.

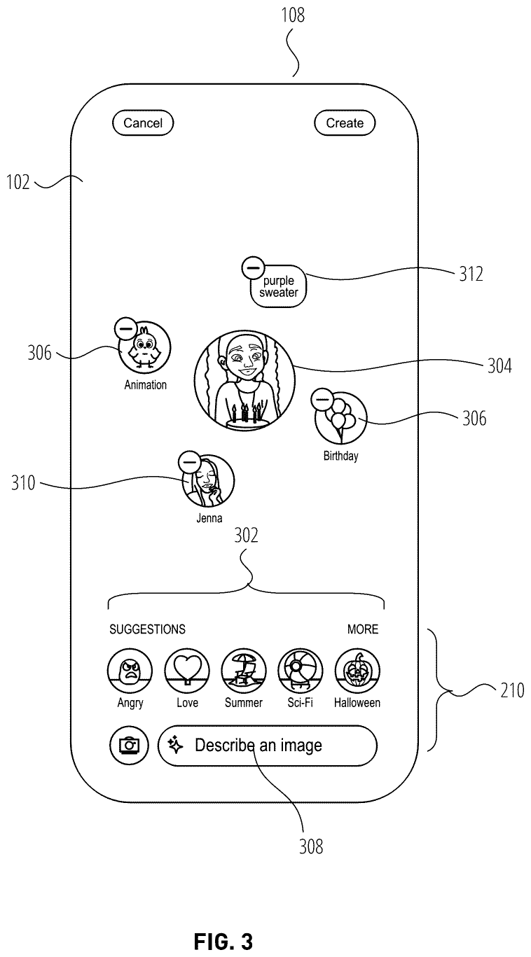

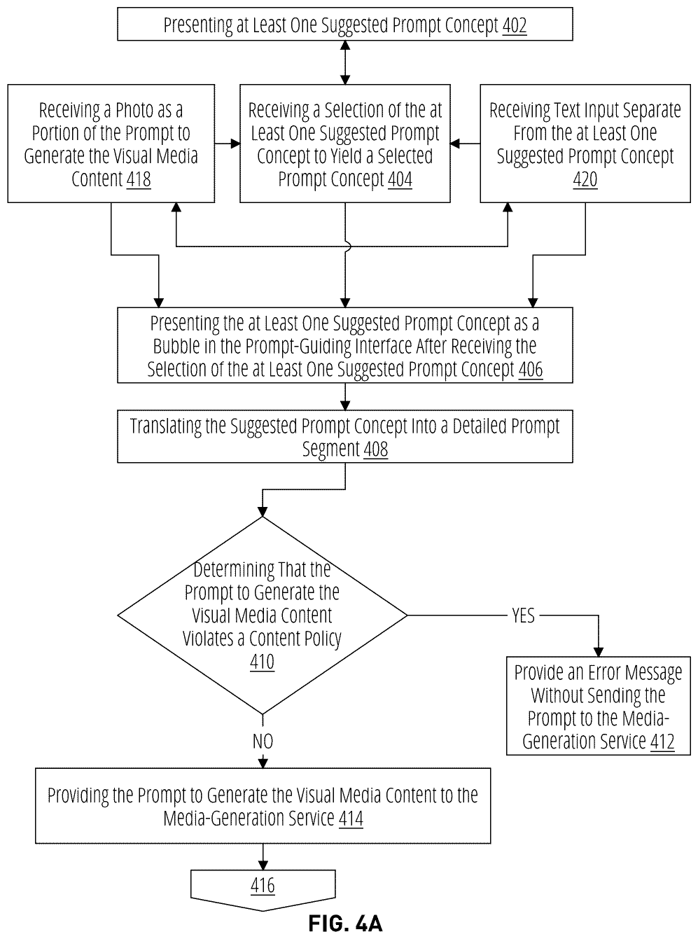

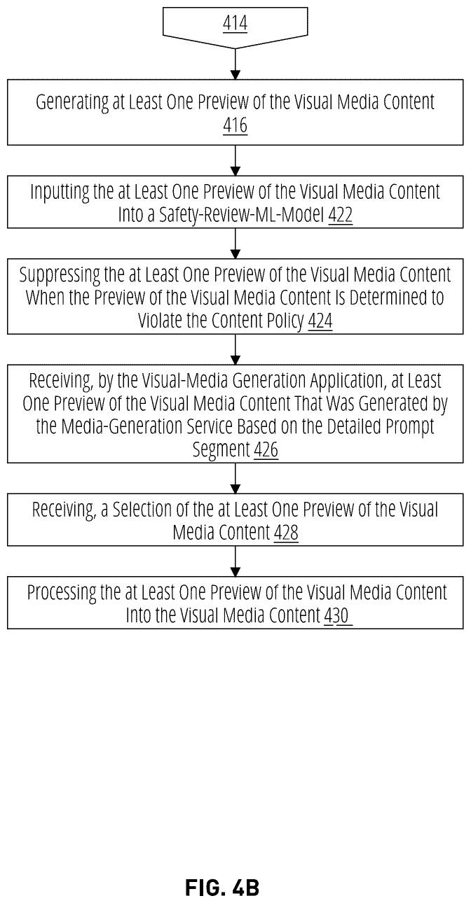

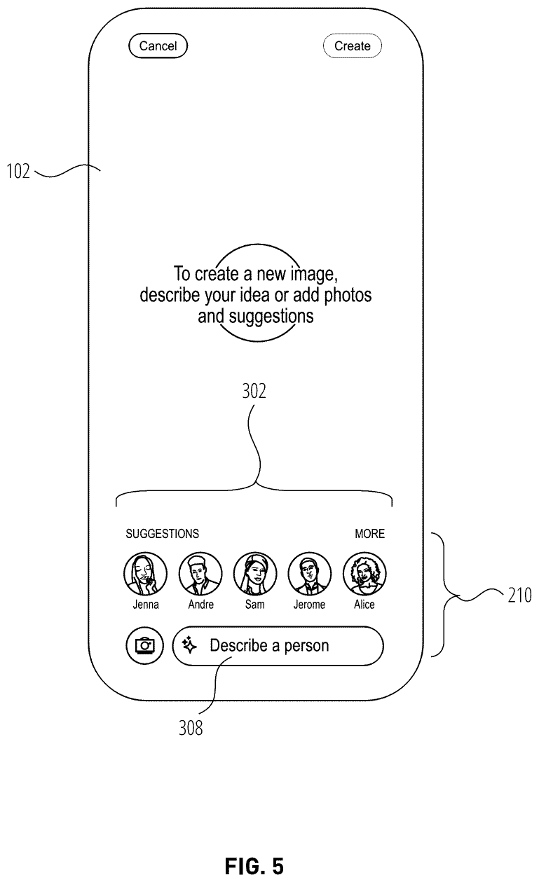

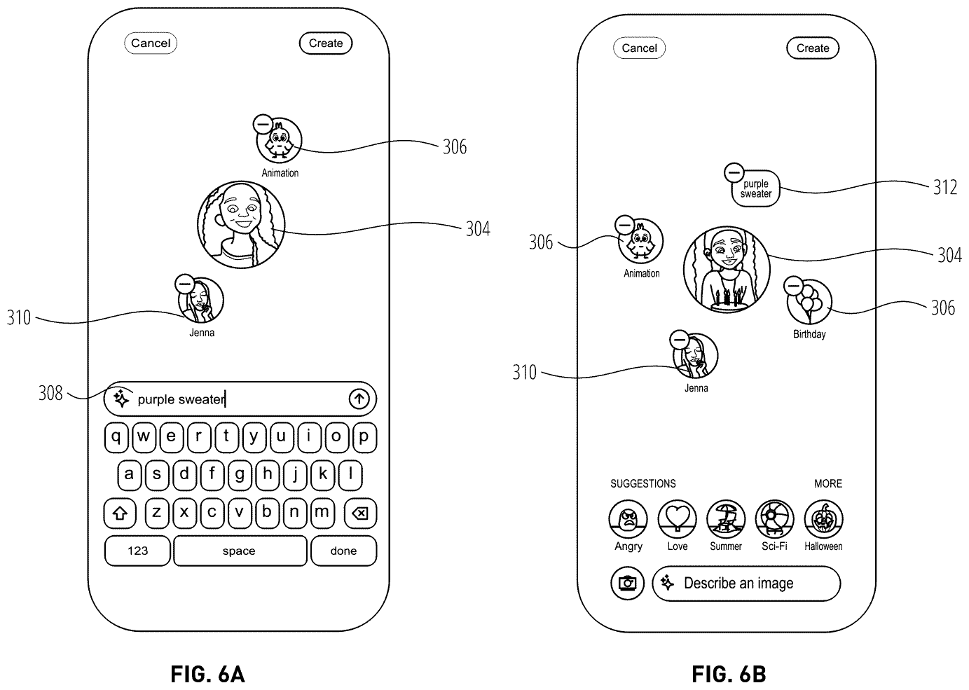

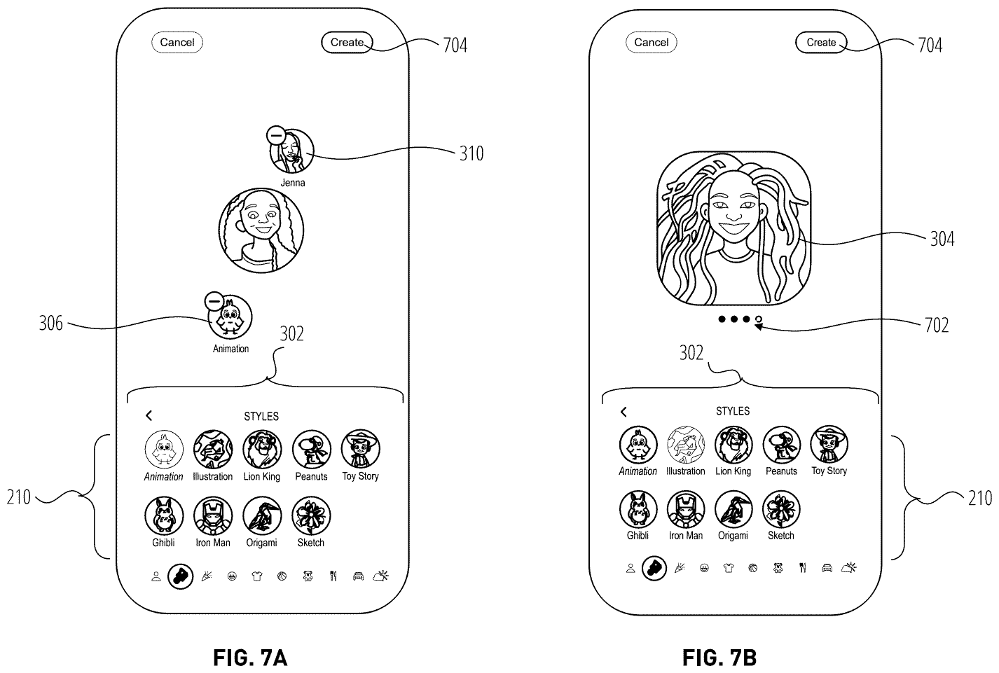

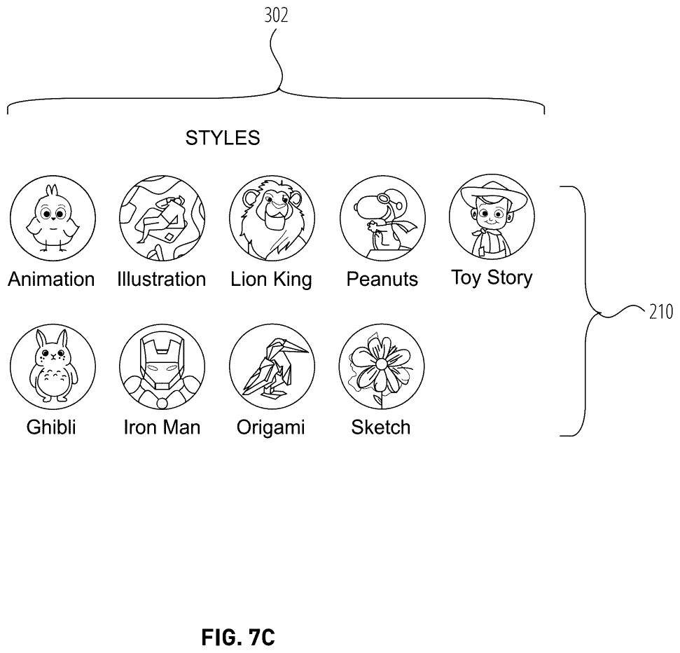

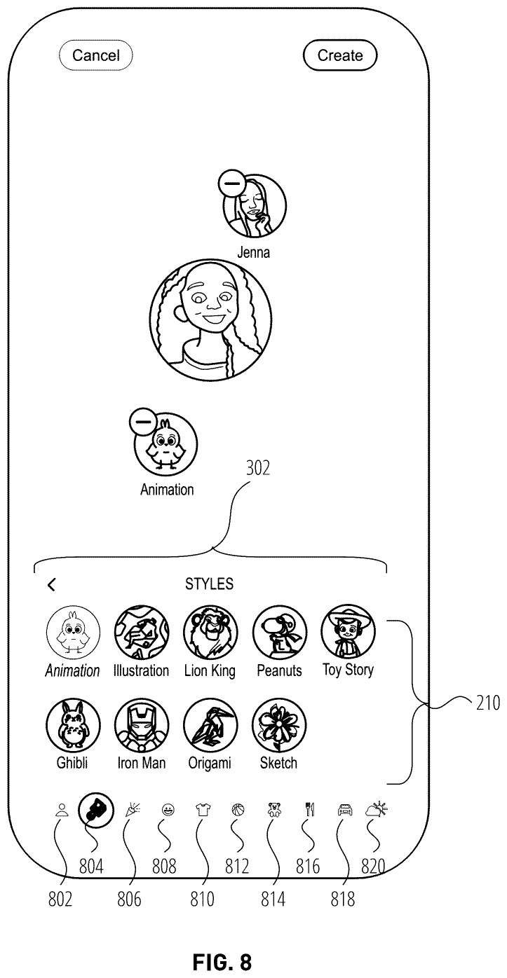

As addressed in more detail herein, but especially with respect to FIG. 3, FIG. 4A, FIG. 4B, FIG. 5, FIG. 6A, FIG. 7A, FIG. 7B, FIG. 7C, and FIG. 8 visual-media generation application 102 includes prompt-guiding interface 210. Prompt-guiding interface 210 is configured to aid a user to generate a sufficiently descriptive prompt through encouraging selections of one or more suggested prompt concepts.

Prompt-guiding interface 210 aids a user in preparing a prompt, and the text portions of the prompt are sent to text encoder 204. Some example methods of text encoding include CLIP (Contrastive Language-Image Pre-training), Text-to-Objective, and text-only encoding. CLIP encoding is a machine learning model that is trained to understand pictures by looking at images paired with text descriptions. It studies these pairs with two separate processes, one for images and one for text, and it's trained to match them. Text-to-Objective encoding involves encoding text to directly serve as an objective or target for AI models, guiding them towards generating outputs that fulfill specific criteria outlined in the text. Text-only encoding converts textual information into a numerical format (e.g., vectors) that models can process. These text-only encoding methods are central to natural language processing (NLP) tasks and are critical for AI that operates on textual data. Techniques such as tokenization, embedding, and the use of pre-trained language models like BERT or GPT fall under this category. Text-only methods enable a wide range of applications, from language translation to sentiment analysis, by providing a mechanism for AI to ‘understand’ and manipulate text.

The image portions of the prompt are sent to image encoder/decoder 206. In some embodiments, the image encoder/decoder 206 can be a machine learning model configured to encode an image or video frame into an encoding interpretable by media-generation service 106. For example, the image encoder/decoder 206 can be similar to the image encoding portion of the CLIP encoder addressed above. In some embodiments, the image encoder/decoder 206 can be variational auto-encoder represents a class of generative artificial intelligence tools that are grounded in the principles of Bayesian inference to learn the underlying probability distribution of data. The variational auto-encoder can encode the input data into a latent representation and decode the latent representation into a pixel representation of the input data from this latent space.

After processing by text encoder 204 and image encoder/decoder 206 the prompts are sent to media-generation service 106, which might select graphical style adapter 104 to assist with the generation of the visual media content. In particular, if the prompt requests an output in a certain style, a graphical style adapter 104 that is optimized to output that style can be selected and used with media-generation service 106.

Media-generation service 106 can output the visual media content in an encoded representation, which is passed back to image encoder/decoder 206, this time for decoding into a pixel-based image or video.

Before presenting the visual media content to the user, the visual media content can be analyzed by 208. The safety model 208 can be a separate machine learning model that is trained to analyze generated visual media content to identify content that might violate a content policy. The safety-review-ML-model is configured to determine whether at least one preview of the visual media content violates a content policy. When the visual media content or a preview thereof violates the content policy, the safety model 208 may suppress the presentation of the visual media content (or a preview thereof) from being presented to the user.

It is preferred that most functions of visual-media generation applications 102 are performed on a local computing device, or at a minimum, functions of visual-media generation applications 102 that occur over a networked connection are functions that are limited in scope and are configured to occur in a privacy-preserving manner. For example, some embodiments of the present technology utilize networked resources, but photos from a user's photo library are not transmitted over a network and are maintained on device 108.

FIG. 3 illustrates an example of visual-media generation application operating on a device in accordance with some embodiments of the present technology. While FIG. 3 illustrates a particular user interface, the present technology should not be considered limited to use with such an interface. Rather, the user interface illustrated in FIG. 3 is provided to illustrate example options and example functionality provided by the present technology.

Visual-media generation application 102 is configured to aid a user in generating a prompt to cause a media-generation service to generate visual media content. While most often, the generated visual media content is expected to be based on an image of a person or an animal that is modified based on a prompt, the image of a person or an animal is not a prerequisite, and the user can use visual-media generation application 102 to generate visual media content from textual prompts alone.

Visual-media generation application 102 is configured to execute on device 108, and to cause device 108 to present prompt-guiding interface 210. Prompt-guiding interface 210 is configured to aid a user to generate a sufficiently descriptive prompt through encouraging selections of one or more suggested prompt concepts 302. As illustrated in FIG. 3, visual-media generation application 102 has presented suggested prompt concepts 302, including prompt concepts such as anger, love, summer, sci-fi, and Halloween, which are all selectable. In some embodiments, there is no limit to the total number of prompt concepts that can be selected or provided, but some prompt concepts might not be compatible with other prompt concepts. For example, a user might only be able to select on type of style in which the visual media content should be generated.

Prompt concepts that are selected can appear in a bubble as a selected prompt concept 306. As illustrated in FIG. 3 the user has already selected several suggested prompt concepts 302, which appear as selected prompt concepts 306. One of the selected prompt concepts 306 is a headshot image of a particular person (image as a prompt concept 310), while the rest of the selected prompt concepts 306 are intended to provoke modifications based on the image of the particular person by media-generation service 106. For example, the user intends that the visual media content produced by media-generation service 106 is an image of the particular person in a style as indicated by a selected style prompt requesting the animation style and having features such as the particular person wearing a purple sweater and having a birthday theme. Some of the prompt concepts are included as the result of a selection of one of the suggested prompt concepts 302, and the user can also provide prompt concepts by providing natural language inputs in text input element 308. The custom text as a prompt concept 312 for ‘purple sweater’ is an example of a natural language input.

Based on the selected prompt concepts 306, the content generation engine can produce a preview of the visual media content 304.

While the prompt-guiding interface addressed herein allows for the selection and entry of both visual and textual prompts, it should be appreciated that the prompt-guiding interface does not require both an image and text and can work with at least a text prompt.

FIG. 4A and FIG. 4B illustrates an example routine for generating an image using a media-generation service from a prompt constructed using a prompt-guiding interface of a visual-media generation application. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes presenting at least one suggested prompt concept at block 402. For example, the prompt-guiding interface 210 illustrated in FIG. 2 may present at least one suggested prompt concept. The at least one suggested prompt concept is suggested for inclusion in a prompt to generate visual media content. In some embodiments, the at least one suggested prompt concept is a photo of a user or animal, such as a pet (see FIG. 5). In some embodiments, the at least one suggested prompt concept is a style, theme, or attribute that is desired to be included in visual media content produced by media-generation service 106 (see FIG. 8). The at least one suggested prompt concept is presented in one or more categories including: people and pets, styles, effects, reactions, outfits, sports, animals, food, travel, and weather.

According to some examples, the method includes receiving a selection of the at least one suggested prompt concept to yield a selected prompt concept at block 404. For example, the prompt-guiding interface 210 illustrated in FIG. 2 may receive a selection of the at least one suggested prompt concept to yield a selected prompt concept. The prompt-guiding interface can receive multiple selections of suggested prompt concepts.

According to some examples, the method includes receiving a photo as a portion of the prompt to generate the visual media content at block 418. For example, the prompt-guiding interface 210 illustrated in FIG. 2 may receive a photo as a portion of the prompt to generate the visual media content (see image as a prompt concept 310 in FIG. 3). In some instances, the photo was selected as a result of being among the suggested prompt concepts, while in other instances a user might have searched for the photo, or captured the image using a camera.

For example, the prompt-guiding interface can access a media library using one or more application programming interfaces (APIs). The media library can include a collection of photos that have textual metadata created by an image classifier that can match the faces of people and pets that reoccur in photos in the photo library. In some embodiments, the photo library can learn a person or pet's name to match with a face that reoccurs in photos in the photo library. The image classifier can also provide descriptions of other aspects of a photo, such as an apparent scene, using both data from the visual content of the photo and other metadata such as geolocation tags associated with the photo. In some embodiments, the classifier can be part of a media-generation service that can generate rich descriptive statements describing the contents of photos. In some embodiments, descriptions generated by the classifier can be indexed for searching or can be placed into an embedding space to allow for semantic meaning matches.

Using this relationship with the photo library that is searchable using language, the prompt-guiding interface can surface faces that have appeared in recent photos or faces that occur often as suggested image prompt. And as will be addressed further herein, a user can provide text prompts or select other suggested prompt concepts to create a personalized image including the person in the image. For example, if the photo library contains a photo of a person named ‘Vinay’ the prompt-guiding interface can suggest a selection of ‘Vinay.’ The user can select ‘Vinay’ and ask for an image of Vinay as a firefighter using textual prompts of selections of suggested prompt concepts.

According to some examples, the method includes receiving text input separate from the at least one suggested prompt concept at block 420. For example, the prompt-guiding interface 210 illustrated in FIG. 2 can also receive text to search for the photo or to generate a custom prompt (see FIG. 6A). The text input can be descriptive of an aspect of the visual media content to be generated. Any received text input can be included as part of the prompt to create the visual media content.

In some embodiments, the text input separate from the at least one suggested prompt concept could also reference a person known to the photo library. For example, a text input could say ‘Vinay as a fire fighter.’ If this were the entire prompt (i.e., the user did not select a photo of Vinay), the present technology can interface with the photo library to retrieve a facial image of Vinay in order to generate the requested image. While, in such an embodiment, the prompt for the media-generation service might also include a photo, just one not explicitly selected by the user, it should be appreciated that there is no requirement for a visual media content such as a photo or face to generate an image—as long as the requested image is not specific to a particular person or pet.

When the prompts include a photo, portions of the prompt to generate the visual media content other than the photo are intended to cause the media-generation service to modify an aspect of the photo.

While FIG. 4A illustrates three sources of prompts: selected prompt concepts, photos (which could be selected from the suggested prompt concepts), and text inputs, any of these are optional. No one type of prompt input is required. Nor is there a requirement to receive the prompt inputs in any particular order. Rather, prompt-guiding interface 210 can accept any of these types of inputs in any order for the purpose of aiding a user in generating a sufficiently detailed prompt.

According to some examples, the method includes presenting the at least one suggested prompt concept as a bubble in the prompt-guiding interface after receiving the selection of the at least one suggested prompt concept at block 406. For example, the prompt-guiding interface 210 illustrated in FIG. 2 may present at least one suggested prompt concept as a bubble in the prompt-guiding interface after receiving the selection of at least one suggested prompt concept. The prompt-guiding interface can receive multiple selections of suggested prompt concepts, and the selections of the suggested prompt concepts are presented as bubbles in the prompt-guiding interface. In addition to the selected suggested prompt concepts, the prompt-guiding interface can also present bubbles for photos and text input. The bubbles represent portions of the prompt to generate the visual media content. A bubble can be deselected to remove the prompt concept from the prompt to generate the visual media content.

According to some examples, the method includes translating the selected prompt concept(s) into a detailed prompt segment at block 408. For example, the visual-media generation application 102 illustrated in FIG. 2 may translate the selected prompt concept(s) into a detailed prompt segment. In some embodiments, the selected prompt concept is represented by just one or two words and an icon to represent the prompt concept. The prompt concepts may imply particular meanings that need to be made explicate to the media-generation service in order to get consistent and good quality visual media content from the media-generation service. Therefore, the selected prompt concept can map to a detailed prompt segment, which are specific text strings that provide detailed instructions for what the selected prompt concept means and how it is intended for the selected prompt concept to be used in modifying the figure. More specifically, the detailed prompt segment includes text that expands the selected prompt concept with specific detail and context pertaining to the selected prompt concept.

For example, a selected prompt concept could be ‘island,’ but this concept is vague. Does this mean that a person in the photos should be shown on an island, or that the photo should have an island theme, or the person should be dressed in island attire? To avoid this ambiguity, the prompt concept of ‘island could be mapped to a detailed prompt segment that specifies that the media-generation service should ‘place the subject of the image in an island setting that includes bright lighting, and one or more of tropical vegetation, beaches, sand, and adjust the subject's attire to be casual attire typical of someone at a tropical resort.’ In some embodiments, an alternative to using a programmed mapping between a selected prompt concept and a detailed prompt segment, a media-generation service such as a large language model can be used to generate a detailed prompt segment, or generate a complete detailed prompt from a collection of selected prompt concepts.

In some embodiments, the use of suggested prompt concepts is not just helpful to users—the suggested prompt concepts are also a safety mechanism. Since the suggested prompt concepts and the detailed prompt segments that they map to are known, there is a level of predictability for the output from media-generation service. More specifically, the media-generation service can have been fine tuned by receiving prompts that include portions containing the detailed prompt segments that correspond to the suggested prompt concepts. During this fine-tuning phase, the media-generation service was rewarded when it output the desired visual media content. This results in a media-generation service that will generally have a predictable behavior when receiving these known prompts.

This is a beneficial safety mechanism because generative artificial intelligence tools have a known drawback of potentially outputting undesirable content, even when given what appears to be an innocuous prompt. This drawback comes from the fact that some generative artificial intelligence tools are trained on vast amounts of data such that it isn't possible for those training the generative artificial intelligence tool to know the content of every image or prompt that the tool was trained on, and such a large source of training data can result in unpredictable outputs. As will be addressed below in greater detail, the media-generation service of the present technology was trained from a filtered dataset of candidate images. In this way, the media-generation service is trained both on a known dataset and known prompt portions-which results in a much more predictable behavior for the media-generation service.

Although the media-generation service was trained to be somewhat inoculated from generating visual media content that might include content that is inappropriate or undesirable for some audiences, and the prompt-guiding interface helps to prevent prompts that might be aimed at generating content that is inappropriate or undesirable for some audiences, such content generation is still a risk with generative artificial intelligence tools. Accordingly, the present technology includes another layer of safety protection.

According to some examples, the method includes determining whether the prompt to generate the visual media content violates a content policy at decision block 410. For example, the visual-media generation application 102 illustrated in FIG. 2 may determine whether the prompt to generate the visual media content violates a content policy. In some embodiments, the prompt to generate the visual media content can be determined to violate the content policy when the combination of detailed prompt segments and/or the text input references prohibited content or is predicted to generate undesirable content.

In some embodiments, the visual-media generation application 102 can include an algorithm or heuristic that is configured to analyze a prompt to attempt to classify the prompt, or a portion of the prompt as violating a content policy. Since the prompt-guiding interface allows for custom text to be entered, it is possible for users to request content to be generated that would violate the content policy. As such the visual-media generation application 102 can include a text filter component that looks for text strings and likely variants of such that are likely to be aimed at generating content that violates the content policy. The visual-media generation application 102 can also include a machine learning algorithm that can analyze a prompt as a whole to attempt to classify the intent of the prompt. As it is possible to create a prompt that is intended to violate a content policy from a collection of otherwise permitted words, some prompts need to be analyzed as a whole. Accordingly, embedding spaces that are designed to map text strings based on intent can be used to determine that the prompt maps to a prohibited intent, or a classifier that is designed to classify prompts as having an intent to violate a content policy, or other technique can be used.

When it is determined that the prompt is intended to generate visual media content that would violate the content policy, or it is determined that, regardless of likely user intent, that the prompt is likely to generate visual media content that would violate the content policy, visual-media generation application 102 can provide an error message without sending the prompt to the media-generation service 106 at block 412.

When it has not been determined that the prompt might violate the content policy, the method includes providing the prompt to generate the visual media content to the media-generation service at block 414. For example, the visual-media generation application 102 illustrated in FIG. 1 may provide the prompt to generate the visual media content to the media-generation service. The prompt to generate the visual media content including the at least one detailed prompt segment.

According to some examples, the method includes generating at least one preview of the visual media content at block 416. For example, the media-generation service 106 illustrated in FIG. 1 may generate at least one preview of the visual media content. In some embodiments, the generating of the preview of the visual media content is aided by a graphical style adapter. As addressed herein, the visual-media generation application 102 can generate a prompt that indicates a particular output style, and the style adaptor can correspond to a style requested in the prompt. In some embodiments, a style might be a required part of a prompt.

FIG. 7C illustrates some example styles that are among the suggested prompt concepts. In some embodiments, each style might correspond to a respective style adaptor. Or some styles might utilize the same style adaptor. For example, when there are sub-styles such as ‘animation,’ ‘Lion King,’ ‘Peanuts,’ ‘Toy Story,’ etc., which are all examples of sub-styles of animation, these all might utilize an animation style adaptor that is versatile enough to cause the media-generation service to output animations according to the selected sub-style. In contrast, the style ‘sketch’ is a distinct artistic style that would utilize a distinct style adaptor from ‘animation’ or any of the sub-styles of animation.

As addressed herein, several steps have been taken to ensure that the media-generation service 106 does not produce content that is inappropriate or undesirable for some audiences. In addition to prompt filtering, and the filtered dataset of candidate images, media-generation service 106 can also be trained to be prohibited from producing certain types of content. However, as indicated above, generative artificial intelligence tools can sometimes provide unpredictable outputs so additional measures are present. An additional layer of protection is provided by way of the safety model 208. The safety model 208 can be a separate machine learning model that is trained to analyze generated visual media content to identify content that might violate a content policy.

According to some examples, the method includes inputting the at least one preview of the visual media content into a safety-review-ML-model at block 422. For example, the safety model 208 illustrated in FIG. 2 may input the at least one preview of the visual media content into a safety-review-ML-model. The safety-review-ML-model is configured to determine whether the at least one preview of the visual media content violates a content policy.

According to some examples, the method includes suppressing the at least one preview of the visual media content when the preview of the visual media content is determined to violate the content policy at block 424. For example, the safety model 208 illustrated in FIG. 2 may suppress at least one preview of the visual media content when the preview of the visual media content is determined to violate the content policy.

According to some examples, the method includes receiving, by the visual-media generation application, at least one preview of the visual media content that was generated by the media-generation service based on the detailed prompt segment at block 426. For example, the visual-media generation application 102 illustrated in FIG. 1 may receive, by the visual-media generation application, at least one preview of the visual media content that was generated by the media-generation service based on the detailed prompt segments. In some embodiments, the at least one preview of the visual media content is two, three, four, or more previews of the visual media content.

One common drawback of generative artificial intelligence tools, especially when they are run ‘on-device,’ as opposed to a cloud computing environment, is that they can consume a lot of computing resources to perform their task and can be slow. However, if the media-generation service 106 is too slow, this will result in a negative user experience. Furthermore, it is common with the use of generative artificial intelligence tools that users can receive an output and modify the prompt several times before getting an output that is acceptable, which can multiply a user's impatience with each prompt revision.

In order to ensure an acceptable user experience, the present technology takes several steps to optimize the graphical style adapters 104 and media-generation service 106 to efficiently run on device 108 and to quickly generate the requested visual media content. One such optimization is that the media-generation service 106 is configured to initially generate thumbnail images. The larger the format, the greater the resolution, the more frames of the output visual media content, the longer the processing time.

In some embodiments, as the prompt is composed of selections of the suggested prompt concepts, typed inputs, and a selection of an image, visual-media generation application 102 can preview a single generated thumbnail image. Once the user has finished the prompt, the user can submit the prompt, causing the media-generation service 106 to generate several thumbnails.

The user can browse through the one or more generated thumbnail images. According to some examples, the method includes receiving, a selection of the at least one preview of the visual media content at block 428. For example, the visual-media generation application 102 illustrated in FIG. 1 may receive, a selection of the at least one preview of the visual media content.

After the selection of the at least one preview of the visual media content, the method includes processing the at least one preview of the visual media content into the visual media content at block 430. For example, the media-generation service 106 illustrated in FIG. 1 may process at least one preview of the visual media content into a visual media content.

As addressed briefly above, the media-generation service 106 can be a diffusion model, which works by making passes over a noisy initial image to remove noise until the noisy input image begins to look like the output image. Therefore, the generation of a low resolution and smaller format preview of the visual media content can be created with less processing passes. This allows the preview of the visual media content to be generated relatively quickly. Then once a single one of the previews of the visual media content is selected, the media-generation service 106 can make further passes over the visual media content to add resolution and upscale the image.

Accordingly, the at least one preview of the visual media content is a generated thumbnail image, and the visual media content is a higher-resolution image and larger format version of the higher-resolution image created by upsampling the generated thumbnail image.

When the requested visual media content is a video, at least one preview of the visual media content is a series of generated thumbnail images representing the video, and the visual media content is a video with additional frames created that includes the generated thumbnail images. The video is created with a reasonable frame rate for the content, and the video created is also in a higher resolution and larger format.

FIG. 5 illustrates a graphical user interface of a visual-media generation application showing a prompt-guiding interface for selecting an image to be included as part of a prompt in accordance with some embodiments of the present technology. While FIG. 5 illustrates a particular user interface, the present technology should not be considered limited to use with such an interface. Rather, the user interface illustrated in FIG. 5 is provided to illustrate example options and example functionality provided by the present technology.

As illustrated in FIG. 5 visual-media generation application 102 includes prompt-guiding interface 210. In FIG. 5 prompt-guiding interface 210 provides one or more suggested prompt concepts 302. These suggested prompt concepts 302 are examples of faces of people and pets identified in the photo library on device 108. Visual-media generation application 102 can call an application programming interface (API) of a photo app to request representative images of commonly recognized faces of people or pets in the photo library.

The prompt-guiding interface 210 also includes a text input element 308. In the context of FIG. 5, text input element 308 can be used to search for an image or headshot of a person or pet in the photo library. In some embodiments, whether or not a person or pet is among the suggested prompt concepts 302, the text input element 308 can be used to find a more specific photo. For example, subjects of photos change over time, especially if the subject is a child over a number of years. Text input element 308 can be used to find a photo of the person when they are of the desired age, or in the right scene or outfit, etc. Text input element 308 can be used to receive any prompt, as will be addressed more specifically with respect to FIG. 6A.

FIG. 6A and FIG. 6B illustrates a graphical user interface of a visual-media generation application showing a prompt-guiding interface receiving text input as part of a prompt in accordance with some embodiments of the present technology. While FIG. 6A and FIG. 6B illustrates a particular user interface, the present technology should not be considered limited to use with such an interface. Rather, the user interface illustrated in FIG. 6A and FIG. 6B is provided to illustrate example options and example functionality provided by the present technology.

As illustrated in FIG. 6A a user can provide a text input into text input element 308. In FIG. 6A, the user has provided the text ‘purple sweater’ to be included as part of the prompt. Since the text ‘purple sweater’ did not correspond to any suggested prompt concept, the text itself becomes part of the prompt as illustrated by custom text as a prompt concept 312 in FIG. 6B.

Between FIG. 6A and FIG. 6B, the user has added custom text as a prompt concept 312, ‘purple sweater’ and has added a suggested prompt concept, ‘birthday’, which is represented as selected prompt concept 306 in FIG. 6B. Responsive to the added prompts, preview of the visual media content 304 has been updated from a headshot of the subject of the image in an animation style in FIG. 6A to the subject wearing a purple sweater and sitting with a birthday cake in FIG. 6B.

FIG. 7A, FIG. 7B, and FIG. 7C illustrates a graphical user interface of a visual-media generation application showing a prompt-guiding interface presenting styles as suggested prompt concepts in accordance with some embodiments of the present technology. While FIG. 7A, FIG. 7B, and FIG. 7C illustrates a particular user interface, the present technology should not be considered limited to use with such an interface. Rather, the user interface illustrated in FIG. 7A, FIG. 7B, and FIG. 7C are provided to illustrate example options and example functionality provided by the present technology.

As addressed herein, the present technology allows a user to provide a desired output style for the visual media content. In some embodiments, a style can be a required part of a prompt.

FIG. 7A, FIG. 7B, and FIG. 7C illustrate prompt-guiding interface 210 with styles as suggested prompt concepts 302. In FIG. 7A ‘animation’ is the selected style shown as selected prompt concept 306, and preview of the visual media content 304 shows the subject of the image as a prompt concept 310 presented in the ‘animation’ style.

In FIG. 7B ‘illustration’ is the selected style, and preview of the visual media content 304 shows the subject of the image as a prompt concept 310 presented in the ‘illustration’ style. FIG. 7B illustrates a slightly different interface than FIG. 7A. Whereas in FIG. 7A the user is building their prompt, in FIG. 7B, the user has built the prompt and already selected create UI button 704. As addressed herein, after the user selects the create UI button 704, media-generation service 106 can return several generated thumbnail images for presentation in thumbnail browsing interface 702 so that the user can review and select a thumbnail to be further processed into a higher-resolution image or video.

FIG. 7C illustrates some example styles that are among the suggested prompt concepts. In some embodiments, each style might correspond to a respective style adaptor. Or some styles might utilize the same style adaptor. For example, when there are sub-styles such as ‘animation,’ ‘Lion King,’ ‘Peanuts,’ ‘Toy Story,’ etc., which are all examples of sub-styles of animation, these all might utilize an animation style adaptor that is versatile enough to cause the media-generation service to output animations according to the selected sub-style. In contrast, the style ‘sketch’ is a distinct artistic style that would utilize a distinct style adaptor from ‘animation’ or any of the sub-styles of animation.

FIG. 8 illustrates a graphical user interface of a visual-media generation application showing categories of suggested prompt concepts presented in a prompt-guiding interface in accordance with some embodiments of the present technology. While FIG. 8 illustrates a particular user interface, the present technology should not be considered limited to use with such an interface. Rather, the user interface illustrated in FIG. 8 is provided to illustrate example options and example functionality provided by the present technology.

In particular, FIG. 8 presents a magnified portion of the prompt-guiding interface 210. Prompt-guiding interface 210 can include a category selector to select categories of suggested prompt concepts. The categories can be navigated by selecting the categories directly or by browsing through suggested prompt concepts in a neighboring category to jump to the next category. FIG. 8 shows that some example categories that can be presented in prompt-guiding interface 210 include: people and pets 802, styles 804, effect 806, reactions 808, outfits 810, sports 812, animals 814, food 816, travel 818, and weather 820.

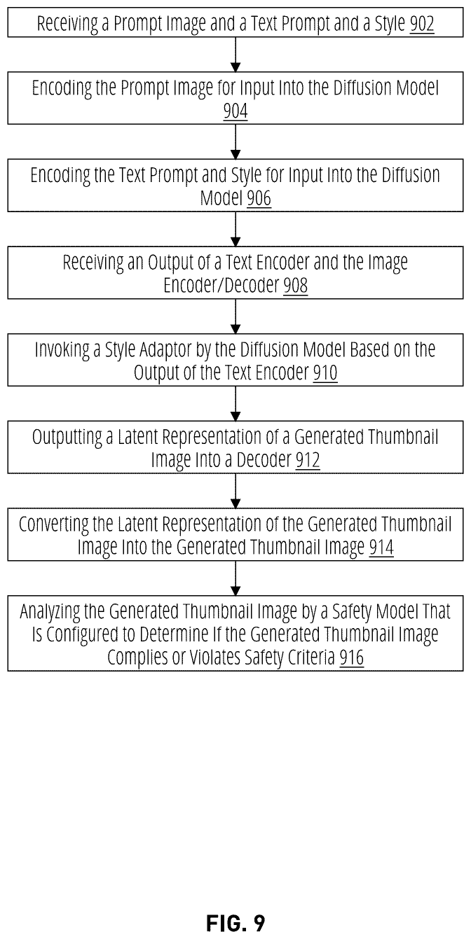

FIG. 9 illustrates an example routine for generating visual media content using the media-generation service in accordance with some embodiments of the present technology. In many aspects, FIG. 9 is repetitive of aspects addressed with respect to FIG. 4A and FIG. 4B, however, FIG. 9 provides additional focus on the architecture of the system, while having less focus on the visual-media generation application. The concepts addressed in FIG. 4A and FIG. 4B should be considered relevant and incorporated in the description of FIG. 9. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a prompt image, a text prompt, and a style at block 902. For example, the visual-media generation application 102 illustrated in FIG. 1 may receive a prompt image, a text prompt, and a style. Of these three inputs, the prompt image is the least important as media-generation service 106 can generate visual media content from a text prompt. The style can be important to cause the media-generation service 106 to select the appropriate graphical style adapter 104.

In some embodiments, the media-generation service 106 is a type of generative model called a diffusion model. A diffusion model refers to a type of generative model used in machine learning that learns to generate data by gradually denoising a signal. It starts with a distribution of random noise and, through a series of steps, progressively refines this noise towards data with the desired characteristics, mimicking a process of reverse diffusion. This approach is particularly notable for its ability to generate high-quality, detailed images.

According to some examples, the method includes encoding the prompt image for input into the diffusion model at block 904. For example, the image encoder/decoder 206 illustrated in FIG. 2 may encode the prompt image for input into the diffusion model. The image portions of the prompt are sent to image encoder/decoder 206. In some embodiments, the image encoder/decoder 206 can be a machine learning model configured to encode an image or video frame into an encoding interpretable by media-generation service 106. For example, the image encoder/decoder 206 can be similar to the image encoding portion of the CLIP encoder addressed above. In some embodiments, the image encoder/decoder 206 can be variational auto-encoder which can encode the input data into a latent representation and decode the latent representation into a pixel representation of the input data from this latent space.

Image encoders streamline the complexity of data into more manageable representations, facilitating a more efficient generation process in terms of both computational resources and time. A noteworthy aspect of image encoders is their capacity to allow for controlled manipulation of the generative process. By adjusting the values in the latent space, it is possible to influence specific characteristics of the output, thereby adding a layer of predictability and customization to the generative process. Integrating diffusion models, which is an example of media-generation service 106, with image encoders introduces a synergistic effect. Diffusion models operate by gradually transforming randomness into structured data through a series of steps, analogous to sculpting a coherent form out of an amorphous mass. The inclusion of an image encoder provides a structured starting point for the diffusion process. This foundational structure means the diffusion model does not start from complete randomness but rather from a point closer to the desired outcome, thus streamlining the path to achieving high-quality, coherent outputs.

Thus the image encoder/decoder 206 can provide at least two benefits that are particularly relevant to the present technology. First, by bringing additional predictability to the generation of visual media content by the media-generation service, there can be additional confidence that the measures taken during model training to ensure that the model does not produce any content that would violate a content policy will bear fruit. Second, since the system illustrated in FIG. 2 is configured to run on-device, the use of image encoder/decoder 206 can bring memory benefits by pipelining the process such that image encoder/decoder 206 is in memory when it is performing its duties and media-generation service 106 is in memory when it is running, and both can be removed from memory when not running. Thus, by breaking down the generative task into two steps, the present technology can utilize memory more efficiently. Additionally, the use of image encoder/decoder 206 can make media-generation service 106 more efficient.

The image encoder/decoder 206 provides still other advantages. The image encoder/decoder 206 can be resolution-independent. This has advantages at training time and inference time. At training time, the image encoder/decoder 206 can be trained on smaller images, which is helpful for efficient training.

As addressed with respect to FIG. 4A and FIG. 4B a user can browse several thumbnails and select one. Since the latent representation is known for the selected generated thumbnail image, that latent representation can be directly input into the media-generation service 106 to request a higher-resolution image, making the processing of the final visual media content more efficient.

Interestingly, during training, experiments were conducted to determine an optimal configuration for the image encoder/decoder 206. The image encoder/decoder 206 receives an image with 4 color channels per pixel as is common with images (Red, Green, Blue, Alpha), and then can be configured to convert the image into less pixels with some number of output channels (that no longer pertain to the typical color channels). It was expected that a higher number of channels would yield better results, but it was found that using 16 channels causes alignment problems in the generated content. Meanwhile, 4 channels yielded better results when combined with sufficient quality input images, and such quality is typical of most input images from photos. Experiments were run with 8-channel output, but the quality of generated visual media content was not appreciably different. Accordingly, surprisingly, 4-channel output worked better than 16-channel output with the on device diffusion model. This also has the benefit that 4-channel output is less computationally intensive too.

According to some examples, the method includes encoding the text prompt and style for input into the diffusion model at block 906. For example, the text encoder 204 illustrated in FIG. 2 may encode the text prompt and style for input into the diffusion model.

The text prompts are also encoded for input into the media-generation service 106. Three methods of text encoding were considered including CLIP (Contrastive Language-Image Pre-training), Text-to-Objective, and text-only encoding. CLIP encoding is a machine learning model that is trained to understand pictures by looking at lot of images paired with text descriptions. It studies these pairs with two separate processes, one for images and one for text, and it's trained to match them in them. CLIP encoding was found to work well. Text-to-Objective encoding involves encoding text to directly serve as an objective or target for AI models, guiding them towards generating outputs that fulfill specific criteria outlined in the text. Surprisingly, Text-to-Objective encoding was not found to work very well. Text-only encoding converts textual information into a numerical format (e.g., vectors) that models can process. These methods are central to natural language processing (NLP) tasks and are critical for AI that operates on textual data. Techniques such as tokenization, embedding, and the use of pre-trained language models like BERT or GPT fall under this category. Text-only methods enable a wide range of applications, from language translation to sentiment analysis, by providing a mechanism for AI to ‘understand’ and manipulate text. Text-only encoding also worked well.

According to some examples, the method includes receiving an output of a text encoder and the variational auto-encoder at block 908. For example, the media-generation service 106 illustrated in FIG. 1 may receive an output of a text encoder and the variational auto-encoder. In some embodiments, media-generation service 106 is a diffusion model. In some embodiments, the diffusion model utilizes a U-Net architecture.

According to some examples, the method includes invoking a style adaptor by the diffusion model based on the output of the text encoder at block 910. For example, the media-generation service 106 illustrated in FIG. 1 may invoke a style adaptor based on the output of the text encoder, wherein the style adaptor corresponds to the style.

According to some examples, the method includes outputting a latent representation of a generated thumbnail image into a decoder at block 912. For example, the media-generation service 106 illustrated in FIG. 1 may output a latent representation of a generated thumbnail image into a variational auto-encoder to be decoded into the visual media content.

According to some examples, the method includes converting the latent representation of the generated thumbnail image into the generated thumbnail image at block 914. For example, the image encoder/decoder 206 illustrated in FIG. 2 may convert the latent representation of the generated thumbnail image into the generated thumbnail image.

As addressed herein, several steps have been taken to ensure that the media-generation service 106 does not produce content that is inappropriate or undesirable for some audiences. In addition to prompt filtering and the filtered dataset of candidate images, media-generation service 106 can also be trained to prohibit certain types of content from being produced. However, as indicated above, generative artificial intelligence tools can sometimes provide unpredictable outputs, so additional measures are needed. An additional layer of protection is provided by way of the safety model 208. The safety model 208 can be a separate machine learning model that is trained to analyze generated visual media content to identify content that might violate a content policy.

According to some examples, the method includes analyzing the generated thumbnail image by a safety model that is configured to determine if the generated thumbnail image complies or violates a content policy at block 916. For example, the safety model 208 illustrated in FIG. 2 may analyze the generated thumbnail image by a safety model that is configured to determine if the generated thumbnail image complies or violates a content policy.

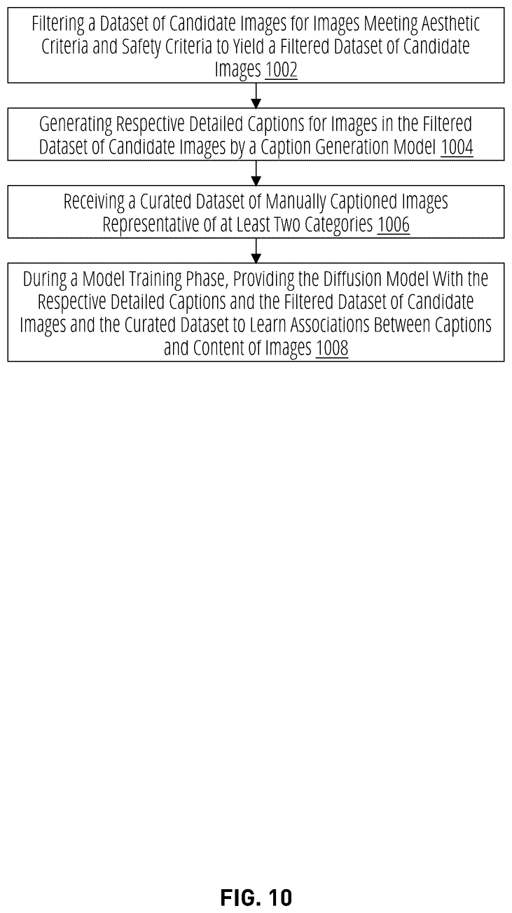

FIG. 10 illustrates an example routine for training a media-generation service with a filtered dataset of candidate images in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In addition to the other techniques addressed herein for training the media-generation service 106, the present technology benefited from an unexpected benefit from training the media-generation service 106 with less data rather than the typical approach to training generative artificial intelligence tools where conventional wisdom suggests more training data is better. Currently, the state of the art is that every few months, a new model with even more training parameters is released, and the models are trained on bigger and bigger datasets. Meanwhile, the present technology has found that filtering a dataset of billion of images with labels to many millions of higher-quality images yielded better results.

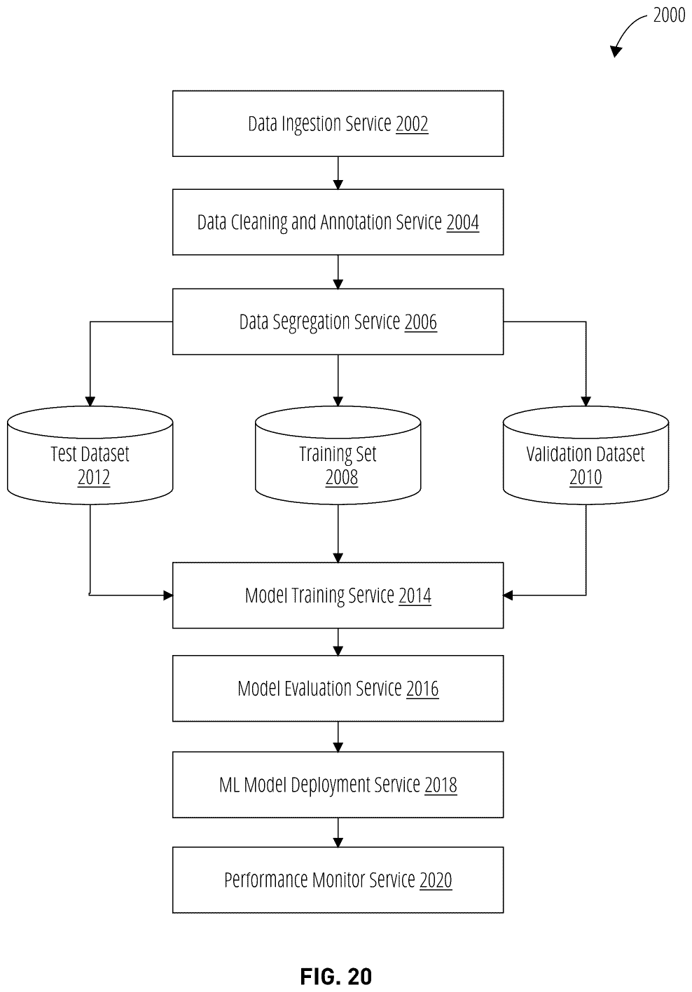

According to some examples, the method includes filtering a dataset of candidate images for images meeting aesthetic criteria and safety criteria to yield a filtered dataset of candidate images at block 1002. For example, the data cleaning and annotation service 2004 illustrated in FIG. 20 may filter a dataset of candidate images for images meeting aesthetic criteria and safety criteria to yield a filtered dataset of candidate images. In some embodiments, an image classifier can be used to identify images that violate a content policy and exclude these images from the data set. In this way, the model will not even be trained on images that contain content that might violate the content policy. Similarly, the dataset can be filtered for images having characteristics of those that the media-generation service will be asked to create.

Typically, the data sets used to train generative artificial intelligence tools are large lists of images with labels associated with the images. However, the present technology found better results could be obtained with more elaborate labels. These labels do more than describe the content of the image, and instead also describe what is happening in the image, the style of the images, predominant colors, and background content.

According to some examples, the method includes generating respective detailed captions for images in the filtered dataset of candidate images by a caption generation model at block 1004. For example, the data cleaning and annotation service 2004 illustrated in FIG. 20 may generate respective detailed captions for images in the filtered dataset of candidate images by a caption-generation model. The caption-generating model is a multi-modal large language model.

In addition to the generated captions, the method includes training on a set of images with high-quality manual captions. Since there are relatively few images in this part of the dataset, they are carefully selected to be distributed across categories of images the media-generation service is likely to receive as prompts.

According to some examples, the method includes receiving a curated dataset of manually captioned images representative of at least two categories at block 1006. For example, the model training service 2014 illustrated in FIG. 20 may receive a curated dataset of manually captioned images representative of at least two categories. The curated dataset includes a deliberate distribution of images across the at least two categories. In reality, there are more than just two categories.

According to some examples, the method includes during a model training phase, providing the diffusion model with the respective detailed captions and the filtered dataset of candidate images of the curated dataset to learn associations between captions and content of images at block 1008. For example, the model training service 2014 illustrated in FIG. 20 may, during a model training phase, first provide the diffusion model with the respective detailed captions of the filtered dataset of candidate images. A fine-tuning phase of training can follow using the data set of manually captioned images.

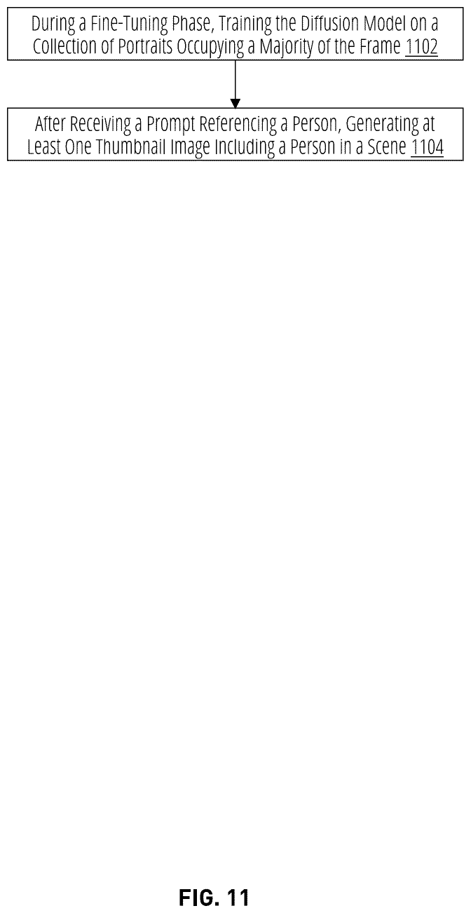

FIG. 11 illustrates an example routine for training the media-generation service to produce images, including faces with improved detail, especially when generating thumbnail images in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In addition to the other techniques addressed herein for training the media-generation service 106, the present technology includes an improvement in training the media-generation service to generate thumbnail images, including faces. Since the images that can be generated by media-generation service running locally on a device will have a somewhat lower resolution than a media-generation service that can run on a cloud, images have less pixels in the image, this also means that the media-generation service has less pixels with which to generate images including realistic facial features.

According to some examples, the method includes during a fine-tuning phase, training the diffusion model on a collection of portraits occupying a majority of the frame at block 1102. For example, the model training service 2014 illustrated in FIG. 20 may, during a fine-tuning phase, train the diffusion model on a collection of portraits occupying a majority of the frame. In this method, the media-generation service is trained on images with a significant amount of facial detail and is trained to generate images with faces a bit more in the foreground so that more pixels can be devoted to facial details. Since most generative artificial intelligence tools are trained to produce high-resolution and large-format images, such a training step has been overlooked but is useful in the context of the present technology, which generates thumbnail images first to make the media-generation service 106 more efficient to facilitate its use on-device.

According to some examples, the method includes generating at least one thumbnail image including a person in a scene based on a prompt referencing a person at block 1104. For example, the media-generation service 106 illustrated in FIG. 1 may generate at least one thumbnail image including a person in a scene. The generated version of at least one thumbnail image, including the person, will exhibit relatively greater detail in facial features than detail exhibited by other objects in the generated thumbnail image. In some embodiments, the generated thumbnail image has a resolution of less than 500 pixels in the vertical or horizontal dimension.

In some embodiments, the prompt referencing the person is supplemented with certain constraints to ensure that the facial features do not overwhelm the image. These constraints can moderate the exaggerated nature of the training set including the collection of portraits occupying a majority of the frame.

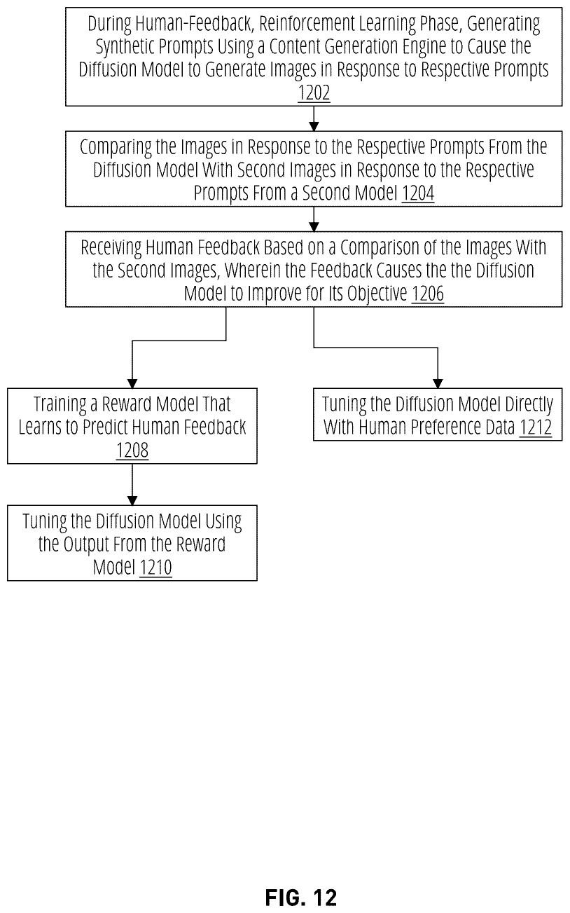

FIG. 12 illustrates an example routine for performing human feedback and reinforcement learning using synthetic prompts in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In addition to the other techniques addressed herein for training the media-generation service 106, the present technology includes an improvement in the human feedback and human-feedback, reinforcement learning phase. Conventionally, when humans are in the loop for the human-feedback, reinforcement learning phase, humans also provide the prompts.

According to some examples, the method includes, during the human-feedback, reinforcement learning phase, generating synthetic prompts using a content generation engine to cause the media-generation service to generate images in response to respective prompts at block 1202. For example, the model training service 2014 illustrated in FIG. 20 may, during the human-feedback, reinforcement learning phase, generate synthetic prompts using a content generation engine to cause the diffusion model to generate images in response to respective prompts.

According to some examples, the method includes comparing the images in response to the respective prompts from the diffusion model with second images in response to the respective prompts from a second model at block 1204. For example, the model evaluation service 2016 illustrated in FIG. 20, in cooperation with a human evaluator, may compare the images in response to the respective prompts from the diffusion model with second images in response to the respective prompts from a second model. In some embodiments, the second model differs from the media-generation service and is characterized by having more trainable parameters than the media-generation service.

According to some examples, the method includes receiving human feedback based on a comparison of the images with the second images, wherein the feedback causes the media-generation service to improve for its objective at block 1206. For example, the model evaluation service 2016 illustrated in FIG. 20 may receive human feedback based on a comparison of the images with the second images, wherein the feedback causes the diffusion model to improve for its objective.′

To tune the diffusion model the method includes two options. A first option is illustrated as block 1208 and block 1210 wherein the method can train a reward model that learns to predict human feedback at block 1208, and then the method can use this reward model to tune the diffusion model at block 1210. A second option is to train the diffusion model directly with human feedback data at block 1212.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, services, and/or components.

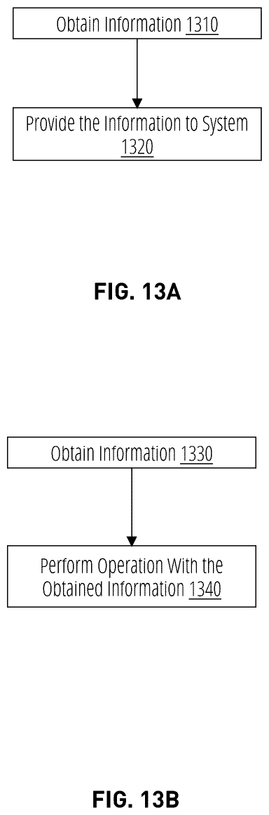

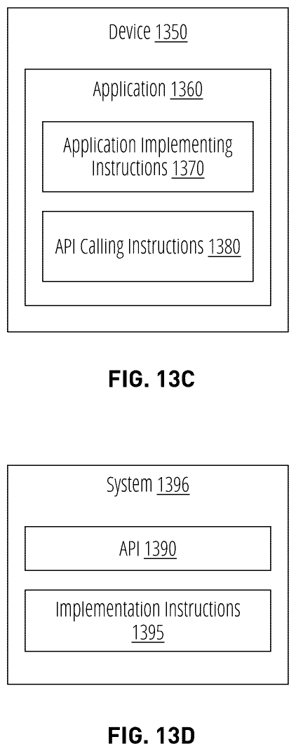

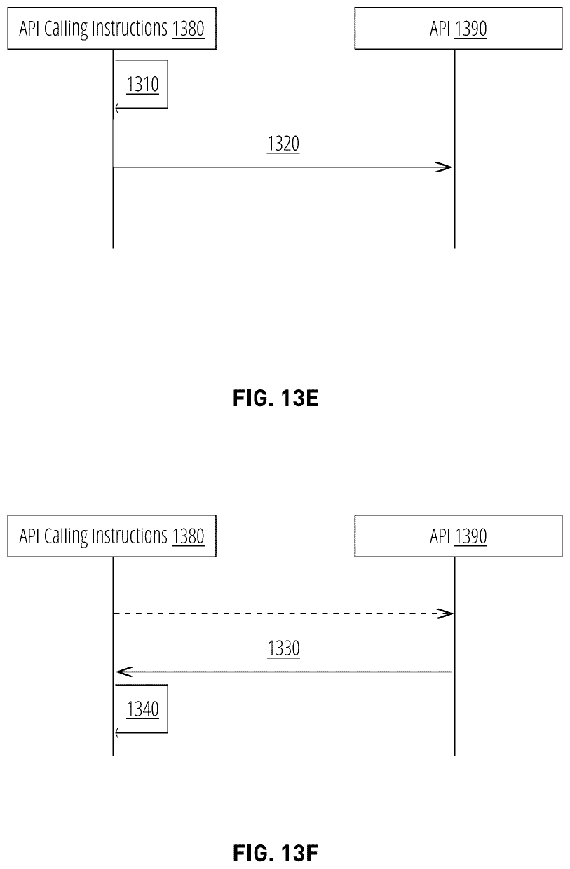

Implementations within the scope of the present disclosure include a computer-readable storage medium that encodes instructions organized as an application (e.g., application 1360) that, when executed by one or more processing units, control an electronic device (e.g., device 1350) to perform the method of FIG. 13A, the method of FIG. 13B, and/or one or more other processes and/or methods described herein.

It should be recognized that application 1360 (shown in FIG. 13C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1360 is an application that is pre-installed on device 1350 at purchase (e.g., a first party application). In other embodiments, application 1360 is an application that is provided to device 1350 via an operating system update file (e.g., a first party application or a second party application). In other embodiments, application 1360 is an application that is provided via an application store. In some embodiments, the application store can be an application store that is pre-installed on device 1350 at purchase (e.g., a first party application store). In other embodiments, the application store is a third-party application store (e.g., an application store that is provided by another application store, downloaded via a network, and/or read from a storage device).

Referring to FIG. 13A and FIG. 13F, application 1360 obtains information (e.g., block 1310). In some embodiments, at block 1310, information is obtained from at least one hardware component of the device 1350. In some embodiments, at block 1310, information is obtained from at least one software module (e.g., set of instructions) of the device 1350. In some embodiments, at block 1310, information is obtained from at least one hardware component external to the device 1350 (e.g., a peripheral device, an accessory device, a server, etc.). In some embodiments, the information obtained at block 1310 includes positional information, time information, notification information, user information, environment information, electronic device state information, weather information, media information, historical information, event information, hardware information, and/or motion information. In some embodiments, in response to and/or after obtaining the information at block 1310, application 1360 provides the information to a system (e.g., block 1320).

In some embodiments, the system (e.g., system 1396 shown in FIG. 13D) is an operating system hosted on the device 1350. In some embodiments, the system (e.g., system 1396 shown in FIG. 13E) is an external device (e.g., a server, a peripheral device, an accessory, a personal computing device, etc.) that includes an operating system.

Referring to FIG. 13B and FIG. 13F, application 1360 obtains information (e.g., block 1330). In some embodiments, the information obtained at block 1330 includes positional information, time information, notification information, user information, environment information electronic device state information, weather information, media information, historical information, event information, hardware information and/or motion information. In response to and/or after obtaining the information at block 1330, application 1360 performs an operation with the information (e.g., block 1340). In some embodiments, the operation performed at block 1340 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1396 based on the information.

In some embodiments, one or more steps of the method of FIG. 13A and/or the method of FIG. 13B is performed in response to a trigger. In some embodiments, the trigger includes detection of an event, a notification received from system 1396, a user input, and/or a response to a call to an API provided by system 1396.

In some embodiments, the instructions of application 1360, when executed, control device 1350 to perform the method of FIG. 13A and/or the method of FIG. 13B by calling an application programming interface (API) (e.g., API 1390) provided by system 1396. In some embodiments, application 1360 performs at least a portion of the method of FIG. 13A and/or the method of FIG. 13B without calling API 1390.

In some embodiments, one or more steps of the method of FIG. 13A and/or the method of FIG. 13B includes calling an API (e.g., API 1390) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 13C, device 1350 is illustrated. In some embodiments, device 1350 is a personal computing device, a smart phone, a smart watch, a fitness tracker, a head mounted display (HMD) device, a media device, a communal device, a speaker, a television, and/or a tablet. Device 1350 includes application 1360 and an operating system (not shown) (e.g., system 1396 shown in FIG. 13D). Application 1360 includes application implementing instructions 1370 and API calling instructions 1380. System 1396 includes API 1390 and implementation instructions 1395. It should be recognized that device 1350, application 1360, and/or system 1396 can include more, fewer, and/or different components than illustrated in FIG. 13C and FIG. 13E.

In some embodiments, application implementing instructions 1370 is a software module that includes a set of one or more computer-executable instructions. In some embodiments, the set of one or more instructions of application implementing instructions 1370 corresponds to one or more operations performed by application 1360. For example, when application 1360 is a messaging application, application implementing instructions 1370 can include operations to receive and send messages. In some embodiments, application implementing instructions 1370 communicates with API calling instructions 1380 to communicate with system 1396 via API 1390 (shown in FIG. 13E).

In some embodiments, API calling instructions 1380 is a software module that includes a set of one or more computer-executable instructions.

In some embodiments, implementation instructions 1395 is a software module that includes a set of one or more computer-executable instructions.

In some embodiments, API 1390 is a software module that includes a set of one or more computer-executable instructions. In some embodiments, API 1390 provides an interface that allows a different set of instructions (e.g., API calling instructions 1380) to access and/or use one or more functions, methods, procedures, data structures, classes, and/or other services provided by implementation instructions 1395 of system 1396. For example, API-calling API calling instructions 1380 can access a feature of implementation instructions 1395 through one or more API calls or invocations (e.g., embodied by a function or a method call) exposed by API 1390 and can pass data and/or control information using one or more parameters via the API calls or invocations. In some embodiments, API 1390 allows application 1360 to use a service provided by a Software Development Kit (SDK) library. In other embodiments, application 1360 incorporates a call to a function or method provided by the SDK library and provided by API 1390 or uses data types or objects defined in the SDK library and provided by API 1390. In some embodiments, API calling instructions 1380 makes an API call via API 1390 to access and use a feature of implementation instructions 1395 that is specified by API 1390. In such embodiments, implementation instructions 1395 can return a value via API 1390 to API calling instructions 1380 in response to the API call. The value can report to application 1360 the capabilities or state of a hardware component of device 1350, including those related to aspects such as input capabilities and state, output capabilities and state, processing capability, power state, storage capacity and state, and/or communications capability. In some embodiments, API 1390 is implemented in part by firmware, microcode, or other low level logic that executes in part on the hardware component.

In some embodiments, API 1390 allows a developer of API calling instructions 1380 (which can be a third-party developer) to leverage a feature provided by implementation instructions 1395. In such embodiments, there can be one or more set of API-calling instructions (e.g., including API calling instructions 1380) that communicate with implementation instructions 1395. In some embodiments, API 1390 allows multiple sets of API calling instructions written in different programming languages to communicate with implementation instructions 1395 (e.g., API 1390 can include features for translating calls and returns between implementation instructions 1395 and API calling instructions 1380) while API 1390 is implemented in terms of a specific programming language. In some embodiments, API calling instructions 1380 calls APIs from different providers such as a set of APIs from an OS provider, another set of APIs from a plug-in provider, and/or another set of APIs from another provider (e.g., the provider of a software library) or creator of the another set of APIs.

Examples of API 1390 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1350. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1395 is a system (e.g., operating system, server system) software module (e.g., a collection of computer-readable instructions) that is constructed to perform an operation in response to receiving an API call via API 1390. In some embodiments, implementation instructions 1395 is constructed to provide an API response (via API 1390) as a result of processing an API call. By way of example, implementation instructions 1395 and API calling instructions 1380 can each be any one of an operating system, a library, a device driver, an API, an application program, or other module. It should be understood that implementation instructions 1395 and API calling instructions 1380 can be the same or different type of software module from each other. In some embodiments, implementation instructions 1395 is embodied at least in part in firmware, microcode, or other hardware logic.

In some embodiments, implementation instructions 1395 returns a value through API 1390 in response to an API call from API calling instructions 1380. While API 1390 defines the syntax and result of an API call (e.g., how to invoke the API call and what the API call does), API 1390 might not reveal how implementation instructions 1395 accomplishes the function specified by the API call. Various API calls are transferred via the one or more application programming interfaces between API calling instructions 1380 and implementation instructions 1395. Transferring the API calls can include issuing, initiating, invoking, calling, receiving, returning, and/or responding to the function calls or messages. In other words, transferring can describe actions by either of API calling instructions 1380 or implementation instructions 1395. In some embodiments, a function call or other invocation of API 1390 sends and/or receives one or more parameters through a parameter list or other structure.

In some embodiments, implementation instructions 1395 provides more than one API, each providing a different view of or with different aspects of functionality implemented by implementation instructions 1395. For example, one API of implementation instructions 1395 can provide a first set of functions and can be exposed to third party developers, and another API of implementation instructions 1395 can be hidden (e.g., not exposed) and provide a subset of the first set of functions and also provide another set of functions, such as testing or debugging functions which are not in the first set of functions. In some embodiments, implementation instructions 1395 calls one or more other components via an underlying API and thus be both an set of API calling instructions and a set of implementation instructions. It should be recognized that implementation instructions 1395 can include additional functions, methods, classes, data structures, and/or other features that are not specified through API 1390 and are not available to API calling instructions 1380. It should also be recognized that API calling instructions 1380 can be on the same system as implementation instructions 1395 or can be located remotely and access implementation instructions 1395 using API 1390 over a network. In some embodiments, implementation instructions 1395, API 1390, and/or API calling instructions 1380 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

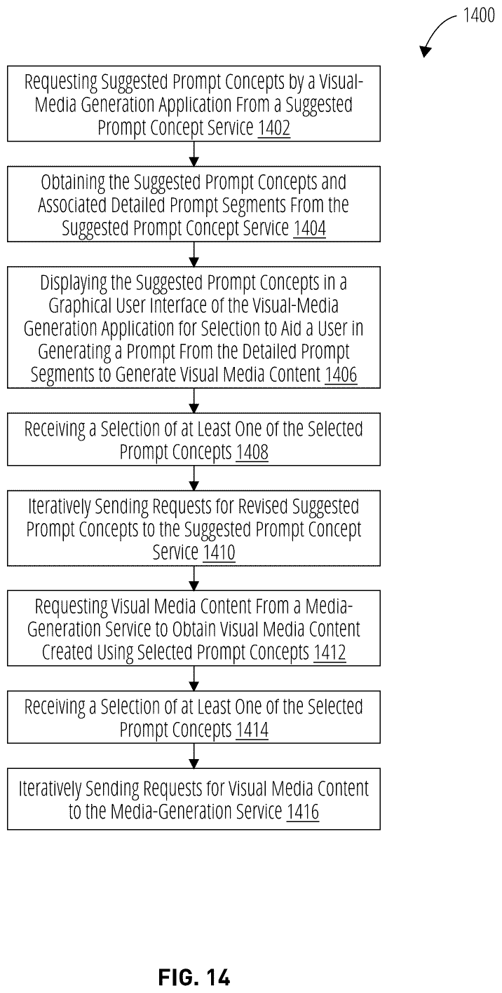

FIG. 14 illustrates an example method 1400 for receiving suggested prompt concepts from a suggested prompt concept service in accordance with some embodiments of the present technology. In some embodiments, the suggested prompt concepts are received in response to a request made via an API to receive the suggested prompt concepts. Although the example method 1400 depicts a particular sequence of operations, the sequence may be altered without departing from the scope of the present disclosure. For example, some of the operations depicted may be performed in parallel or in a different sequence that does not materially affect the function of the method 1400. In other examples, different components of an example device or system that implements the method 1400 may perform functions at substantially the same time or in a specific sequence.

In some embodiments, method 1400 is performed at a first computer system (as described herein) by an application that is different from a system process. In some embodiments, the instructions of the application, when executed, control the first computer system to perform method 1400 by calling an application programming interface (API) provided by the system process. In some embodiments, the application performs at least a portion of method 1400 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. A particular example of the application is the visual-media generation application 102 or the prompt-guiding interface presented within the visual-media generation application 102.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 1400 (FIG. 14) by calling an application programming interface (API) provided by the system process using one or more parameters.

As described here, a user account can interact with a visual-media generation application to result in generation of a detailed prompt that can be used by a media-generation service to generate media. FIG. 14 pertains to embodiments of the visual-media generation application where the visual-media generation application calls an API to request suggested prompt concepts that can be displayed within the visual-media generation application or the visual-media generation application calls an API to request a prompt-guiding interface along with the suggested prompt concepts. Additionally, the visual-media generation application can also call an API to a media-generation service to result in the generation of media for presentation in the visual-media generation application.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

According to some examples, the method includes requesting suggested prompt concepts by a visual-media generation application from a suggested prompt concept service at block 1402. The request for suggested prompt concepts can be made through an API of the suggested prompt concept service. As addressed herein, the visual-media generation application can present initial suggested prompt concepts, or the visual-media generation application can receive a text input descriptive of a desired prompt concept, or descriptive of a particular entity represented in a photo service in which the user account stores images and videos. When a text string is provided, the request for the suggested prompt concepts includes a text string descriptive of a desired prompt concept. In some embodiments, the request for the suggested prompt concepts can be a request for the prompt-guiding interface, which can display the prompts and permit selections of the prompts as addressed herein.

According to some examples, the method includes obtaining the suggested prompt concepts and associated detailed prompt segments from the suggested prompt concept service at block 1404. When a text string descriptive of a desired prompt concept is provided with the request, the suggested prompt concepts obtained from the suggested prompt concept service are relevant to the text string. When the prompt-guiding interface is requested, a link to an instance of the prompt-guiding interface can be returned, and the prompt-guiding interface can include the suggested prompt concepts.

According to some examples, the method includes displaying the suggested prompt concepts in a graphical user interface of the visual-media generation application for selection to aid a user in generating a prompt from the detailed prompt segments to generate visual media content at block 1406. This is similar to that illustrated in FIG. 5, FIG. 6B, FIG. 7A, FIG. 7B, and FIG. 8.

According to some examples, the method includes receiving a selection of at least one of the selected prompt concepts at block 1408.

According to some examples, the method includes iteratively sending requests for revised suggested prompt concepts to the suggested prompt concept service at block 1410. The requests for revised suggested prompt concepts are made after the selection or a deselection of a particular suggested prompt concept. The request for revised suggested prompt concepts includes an identification of the currently selected prompt concepts.

According to some examples, the method includes requesting visual media content from a media-generation service to obtain visual media content created using selected prompt concepts at block 1412. The request for the visual media content can be made through an API of the suggested media-generation service.

According to some examples, the method includes iteratively receiving a selection of at least one of the selected prompt concepts at block 1414.

According to some examples, the method includes iteratively sending requests for visual media content to the media-generation service at block 1416. The requests for revised visual media content are made after the selection or a deselection of a particular suggested prompt concept. The request for visual media content includes prompts based on the selected prompt concepts.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., device 1350) that runs the application. In some embodiments, the set of implementation instructions is included in an electronic device that is separate from the device that runs the application.

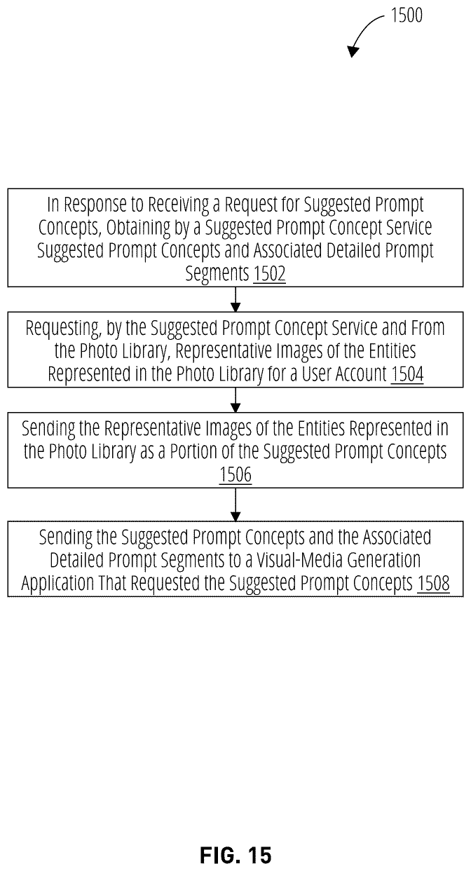

FIG. 15 illustrates an example method 1500 for receiving a request to provide, and providing, suggested prompt concepts from a visual-media generation application in accordance with some embodiments of the present technology. In some embodiments, the request is received via an API. Although the example method 1500 depicts a particular sequence of operations, the sequence may be altered without departing from the scope of the present disclosure. For example, some of the operations depicted may be performed in parallel or in a different sequence that does not materially affect the function of the method 1500. In other examples, different components of an example device or system that implements the method 1500 may perform functions at substantially the same time or in a specific sequence.

In some embodiments, method 1500 is performed at a first computer system (as described herein) via a system process (e.g., an operating system process, a server system process) that is different from one or more applications executing and/or installed on the first computer system.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions. With respect to FIG. 15 a suggested prompt concept service receives a request for suggested prompt concepts via an API called by the visual-media generation application or prompt-guiding interface.

According to some examples, the method includes receiving a request for suggested prompt concepts by a suggested prompt concept service or prompt-guiding interface and, in response to receiving the request, obtaining the suggested prompt concepts and associated detailed prompt segments at block 1502. For example, in some embodiments, the request can be from block 1402 in FIG. 14 where a visual-media generation application requests the suggested prompt concepts via an API provided by the suggested prompt concept service.

According to some examples, the method includes requesting, by the suggested prompt concept service and from the photo library, representative images of the entities represented in the photo library for a user account at block 1504. For example, in order to respond to the request received at block 1502, the suggested prompt concept service may need to request data from one or more other services that expose respective APIs.

With respect to block 1504, the suggested prompt concept service can call a photo library via an API provided by the photo library. In response, the photo library can send the representative images of the entities represented in the photo library, which can be used as a portion of the suggested prompt concepts requested at block 1402 (received at block 1502). When the request for the representative photo includes text that is descriptive of the desired representative photo, the API provided by the photo library can accept the text as a parameter of the API call and can return representative photos that match or correspond to the descriptive text of the desired representative photo.

According to some examples, the method includes sending the representative images of the entities represented in the photo library to the visual-media generation application as a portion of the suggested prompt concepts at block 1506. An example of the representative images can be seen in FIG. 5 as suggested prompt concept 302.

According to some examples, the method includes sending the suggested prompt concepts and the associated detailed prompt segments to the visual-media generation application that requested the suggested prompt concepts at block 1508. Block 1508 completes the response to the request received at block 1502.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., device 1350) that runs the application. In some embodiments, the set of implementation instructions is included in an electronic device that is separate from the device that runs the application.

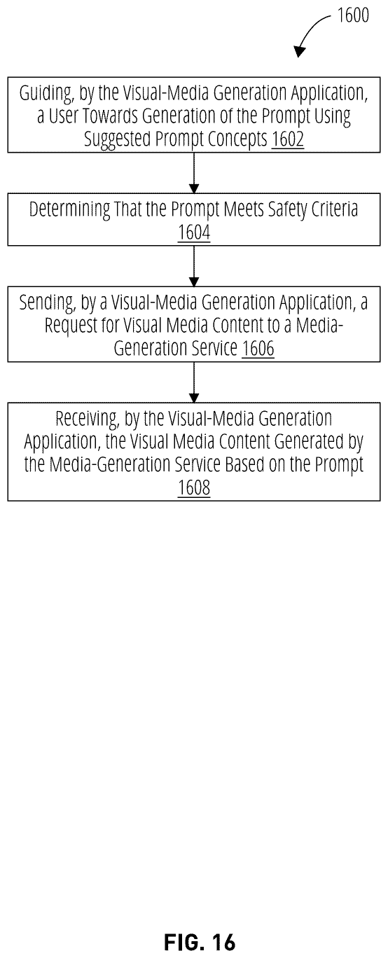

FIG. 16 illustrates an example method 1600 for requesting the generation of visual media content in accordance with some embodiments of the present technology. Although the example method 1600 depicts a particular sequence of operations, the sequence may be altered without departing from the scope of the present disclosure. For example, some of the operations depicted may be performed in parallel or in a different sequence that does not materially affect the function of the method 1600. In other examples, different components of an example device or system that implements the method 1600 may perform functions at substantially the same time or in a specific sequence.

In some embodiments, method 1600 is performed at a first computer system (as described herein) by an application that is different from a system process. In some embodiments, the instructions of the application, when executed, control the first computer system to perform method 1600 by calling an application programming interface (API) provided by the system process. In some embodiments, the application performs at least a portion of method 1600 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. A particular example of the application is the visual-media generation application 102 or the prompt-guiding interface.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 1600 by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As addressed herein, the visual-media generation application or prompt-guiding interface can provide suggested prompt concepts, which can be selected by a user to generate a prompt. Accordingly, the method includes guiding a user towards the generation of the prompt using suggested prompt concepts at block 1602.

In some embodiments, prompts can be reviewed against safety criteria. In some embodiments, the prompt can be reviewed by safety criteria of the visual-media generation application, the media-generation service or both. FIG. 16 illustrates reviewing the prompt against safety criteria by the visual-media generation application. According to some examples, the method includes determining that the prompt meets safety criteria at block 1604.

After the prompt is deemed to comply with the safety criteria, the method includes sending, by a visual-media generation application, a request for visual media content to a media-generation service at block 1606. The request for the visual media content includes the prompt that was reviewed against the safety criteria to be used in the generation of the visual media content. In some embodiments, the request is made by calling an API provided by the media-generation service. The prompt and the identification of a desired style can be included as parameters in the API call to the media-generation service.

According to some examples, the method includes receiving, by the visual-media generation application, the visual media content generated by the media-generation service based on the prompt at block 1608. The visual-media generation application can display (or cause to be displayed) the visual media content to the user.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., device 1350) that runs the application. In some embodiments, the set of implementation instructions is included in an electronic device that is separate from the device that runs the application.

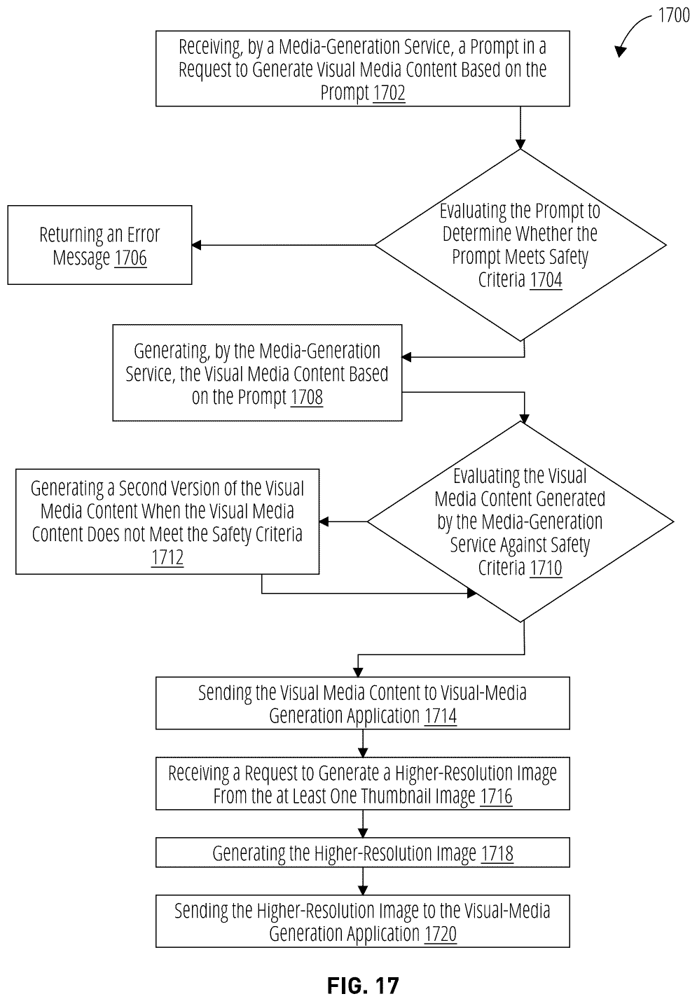

FIG. 17 illustrates an example method 1700 for receiving a request to generate visual media content based on a prompt and steps associated with replying to the request in accordance with some embodiments of the present technology. Although the example method 1700 depicts a particular sequence of operations, the sequence may be altered without departing from the scope of the present disclosure. For example, some of the operations depicted may be performed in parallel or in a different sequence that does not materially affect the function of the method 1700. In other examples, different components of an example device or system that implements the method 1700 may perform functions at substantially the same time or in a specific sequence.

In some embodiments, method 1500 is performed at a first computer system (as described herein) via a system process (e.g., an operating system process, a server system process) that is different from one or more applications executing and/or installed on the first computer system.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions. With respect to FIG. 17 a media-generation service receives a request for visual media content via an API called by the visual-media generation application.

As addressed herein, a prompt can be provided to a media-generation service to cause the media-generation service to generate one or more images or thumbnails thereof. In FIG. 17, the media-generation service can provide an API to receive the prompt and/or an identification of a style and return the one or more images. According to some examples, the method includes receiving, by the media-generation service, a request to generate visual media content based on the prompt included in the request (e.g., an API call) at block 1702.

In some embodiments, the request is received from a visual-media generation application, but other applications might also call the API provided by the media-generation service too.

According to some examples, the method includes evaluating the prompt to determine whether the prompt meets safety criteria at decision block 1704. For example, the prompt can be evaluated to ensure that it complies with a content policy. The content policy might be configured to identify prompts that appear to be requesting visual media that depicts violence or content that is inappropriate or undesirable for some audiences. It is noted that similar functionality has been addressed as being provided by a visual-media generation application that is used to configure the prompt; the description with respected to FIG. 17 can be in addition to or an alternative to the evaluation of the prompt against a content policy described elsewhere herein.

According to some examples, the method includes returning an error message at block 1706 when the prompt does not comply with the content policy. In some embodiments, the error message can inform the user that the prompt will need to be revised before visual media content can be generated.

According to some examples, the method includes generating, by the media-generation service, the visual media content based on the prompt when the prompt complies with the content policy at block 1708. The generating the visual media content based on the prompt includes generating at least one thumbnail image.

As described herein, multiple layers of safety services can be used to ensure that content that is inappropriate or undesirable for some audiences is not presented to the user. One layer is the evaluation of the prompt at decision block 1704, and another layer is the evaluation of the generated image at decision block 1710. According to some examples, the method includes evaluating the visual media content generated by the media-generation service against safety criteria at decision block 1710. The visual media content is analyzed because some prompts that appear to be acceptable might still cause the media-generation service to generate content that is inappropriate or undesirable for some audiences. Accordingly, multiple layers of content policy or safety checks can be performed.

According to some examples, the method includes generating a second version of the visual media content when the visual media content does not meet the safety criteria at block 1712. Some technologies that generate visual media content based on prompts can generate different versions based on the same prompt. Accordingly, when content generated by the media-generation service violates the safety criteria at decision block 1710, regenerating the content at block 1714 can sometimes generate visual media content that does comply with the safety criteria. In some embodiments, the prompt can also be modified to include an instruction on how to comply with the safety criteria.

According to some examples, the method includes sending the visual media content to visual-media generation application when the visual media content complies with the safety criteria at block 1714. The sending of the visual media content can be the response to the API call received at block 1702.

According to some examples, the method includes receiving a request to generate a higher-resolution image from the at least one thumbnail image at block 1716. When the visual media content that was returned at block 1714 was a thumbnail image, the calling application might send a further API call to request a full resolution image.

According to some examples, the method includes generating the higher-resolution image at block 1718 and sending the higher-resolution image to the visual-media generation application at block 1720.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., device 1350) that runs the application. In some embodiments, the set of implementation instructions is included in an electronic device that is separate from the device that runs the application.

FIG. 18 is a system diagram illustrating device 1800 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Device 1800 may perform various operations including image processing. For this and other purposes, the device 1800 may include, among other components, image sensor 1801, system-on-a system on a chip 1802, system memory 1817, persistent storage 1816, motion sensor 1819, and display 1810.

Image sensor 1801 is a component for capturing image data and may be embodied, for example, as a complementary metal-oxide-semiconductor (CMOS) active-pixel sensor) a camera, video camera, or other devices. Image sensor 1801 generates raw image data that is sent to system on a chip 1802 for further processing. In some embodiments, the image data processed by system on a chip 1802 is displayed on display 1810, stored in system memory 1817, persistent storage 1816 or sent to a remote computing device via network connection. The raw image data generated by image sensor 1801 may be in a Bayer color filter array (CFA) pattern (hereinafter also referred to as “Bayer pattern”).

Strobe controller 1805 is a component for controlling variable features of strobe 1804. Some attributes of the strobe 1804 profile that can be adjusted include a strobe duration, a strobe strength, strobe spectrum, and an angular profile. For example, some strobe 1804 devices can include strobes with adjustable intensities, and some strobe devices include multiple strobes, maybe with different emission spectra that can be activated independently to control an angular profile or spectrum of the light emitted from the strobe. An angular profile refers to the pattern and spread of light emitted from the strobe unit as it disperses over an area, as well as how this dispersion changes at different angles relative to the strobe. This can include how the intensity and distribution of light vary as one moves away from the central axis of the strobe, which is directly in front of it, towards the sides.

Motion sensor 1819 is a component or a set of components for sensing motion of device 1800. Motion sensor 1819 may generate sensor signals indicative of orientation and/or acceleration of device 1800. The sensor signals are sent to system on a chip 1802 for various operations such rotating images displayed on display 1810, and tracking motion of the image sensor 1801 during image capture.

Display 1810 is a component for displaying images as generated by system on a chip 1802. Display 1810 may include, for example, liquid crystal display (LCD) device or an organic light emitting diode (OLED) device. Based on data received from system on a chip 1802, display 1810 may display various images, such as menus, selected operating parameters, images captured by image sensor 1801 and processed by system on a chip 1802, and/or other information received from a user interface of device 1800 (not shown).

System memory 1817 is a component for storing instructions for execution by system on a chip 1802 and for storing data processed by system on a chip 1802. System memory 1817 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 1817 may store pixel data or other image data or statistics in various formats. System memory 1817 can be accessible by many of the components of the system on a chip 1802, including, but not limited to the central processing unit 1806, graphics processing unit 1812, and neural engine 1820.

Persistent storage 1816 is a component for storing data in a non-volatile manner. Persistent storage 1816 retains data even when power is not available. Persistent storage 1816 may be embodied as read-only memory (ROM), NAND or NOR strobe memory or other non-volatile random access memory devices.

System on a chip 1802 is embodied as one or more integrated circuit (IC) chips and performs various data processing processes. System on a chip 1802 may include, among other components, image signal processor 1803, one or more central processing unit 1806, network interface 1807, sensor interface 1808, display controller 1809, one or more graphics processing unit 1812, memory controller 1813, video encoder 1814, storage controller 1815, one or more neural engine 1820 and various other input/output (I/O) I/O interfaces 1811, and bus 1818. Some components of system on a chip 1802 can be connected directly to system memory 1817, while other components are connect to other components by bus 1818. System on a chip 1802 may include more or fewer components than those shown in FIG. 18.

Image signal processor 1803 (ISP) is hardware that performs various stages of an image processing pipeline. In some embodiments, image signal processor 1803 may receive raw image data from image sensor 1801, and process the raw image data into a form that is usable by other subcomponents of system on a chip 1802 or components of device 1800. image signal processor 1803 may perform various image-manipulation operations such as image translation operations, horizontal and vertical scaling, color space conversion and/or image stabilization transformations.

Central processing unit 1806 (CPU) may be embodied using any suitable instruction set architecture, and may be configured to execute instructions defined in that instruction set architecture. Central processing unit 1806 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 18, system on a chip 1802 may include multiple CPUs. In multiprocessor systems, each of the CPUs may commonly, but not necessarily, implement the same ISA.

Graphics processing unit 1812 (GPU) is graphics processing circuitry for performing graphical data. For example, GPU may render objects to be displayed into a frame buffer (e.g., one that includes pixel data for an entire frame). Graphics processing unit 1812 may include one or more graphics processors that may execute graphics software to perform a part or all of the graphics operation, or hardware acceleration of certain graphics operations.

Neural engine 1820 includes one or more processing cores optimized for machine learning tasks including training and inference tasks. Neural engine 1820 enables rapid processing of artificial intelligence (AI) and machine learning (ML) operations. Neural engine 1820 is optimized for tasks such as advanced image processing, natural language processing, and pattern recognition, significantly improving the efficiency and speed of AI-related processes. Its architecture is designed to support a wide range of machine learning models while being highly energy-efficient, thereby enhancing the user experience through faster, more responsive applications and functionalities that rely on AI and ML technologies.

I/O interfaces 1811 are hardware, software, firmware or combinations thereof for interfacing with various input/output components in device 1800. I/O components may include devices such as keypads, buttons, audio devices, and sensors such as a global positioning system. I/O interfaces 1811 process data for sending data to such I/O components or process data received from such I/O components.

Network interface 1807 is enables data to be exchanged between devices device 1800 and other devices via one or more networks (e.g., carrier or agent devices). For example, video or other image data may be received from other devices via network interface 1807 and be stored in system memory 1817 for subsequent processing (e.g., via a back-end interface to image signal processor 1803) and display. The networks may include, but are not limited to, Local Area Networks (LANs) (e.g., an Ethernet or corporate network) and Wide Area Networks (WANs). The image data received via network interface 1807 may undergo image processing processes by image signal processor 1803.

Sensor interface 1808 is circuitry for interfacing with motion sensor 1819. Sensor interface 1808 receives sensor information from motion sensor 1819 and processes the sensor information to determine the orientation or movement of the device 1800.

Display controller 1809 is circuitry for sending image data to be displayed on display 1810. Display controller 1809 receives the image data from image signal processor 1803, central processing unit 1806, graphics processing unit 1812 or system memory 1817 and processes the image data into a format suitable for display on display 1810.

Memory controller 1813 is circuitry for communicating with system memory 1817. Memory controller 1813 may read data from system memory 1817 for processing by image signal processor 1803, central processing unit 1806, graphics processing unit 1812 or other subcomponents of system on a chip 1802. Memory controller 1813 may also write data to system memory 1817 received from various subcomponents of system on a chip 1802.

Video encoder 1814 is hardware, software, firmware or a combination thereof for encoding video data into a format suitable for storing in persistent storage 1816 or for passing the data to network interface 1807 for transmission over a network to another device.

In some embodiments, one or more components of system on a chip 1802 or some functionality of these components may be performed by software components executed on image signal processor 1803, central processing unit 1806, graphics processing unit 1812. Such software components may be stored in system memory 1817, persistent storage 1816 or another device communicating with device 1800 via network interface 1807.

Image data or video data may flow through various data paths within system on a chip 1802. In one example, raw image data may be generated from the image sensor 1801 and processed by image signal processor 1803, and then sent to system memory 1817. After the image data is stored in system memory 1817, it may be accessed by graphics processing unit 1812, neural engine 1820, and/or video encoder 1814 for encoding or display 1810.

In another example, image data is received from sources other than the image sensor 1801. For example, video data may be streamed, downloaded, or otherwise communicated to the system on a chip 1802 via wired or wireless network. The image data may be received via network interface 1807 and written to system memory 1817 via memory controller 1813. The image data may then be obtained from system memory 1817 and processed image signal processor 1803, graphics processing unit 1812, or neural engine 1820. The image data may then be returned to system memory 1817.

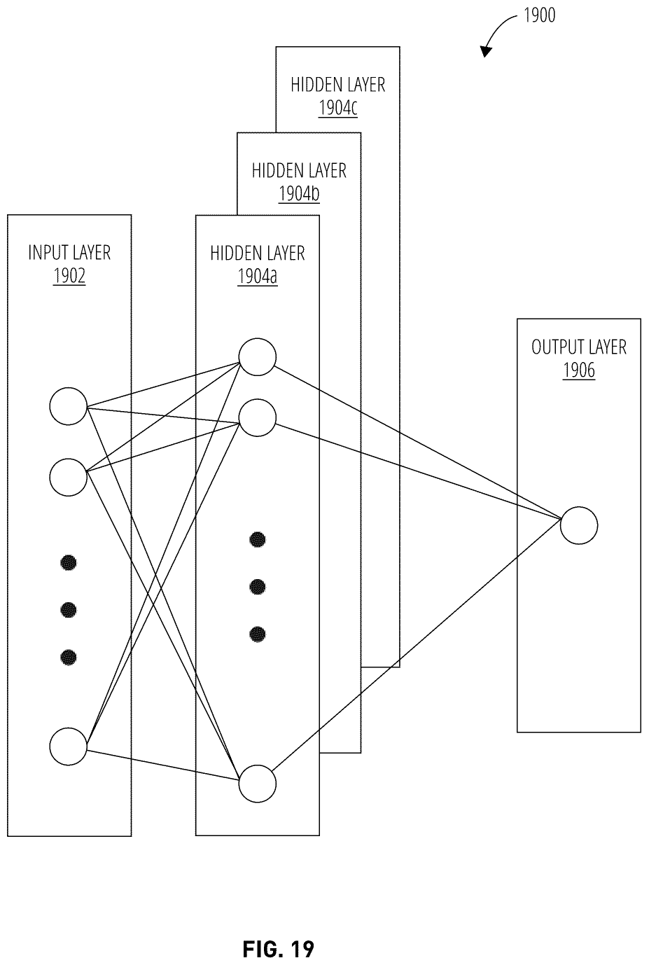

In FIG. 19, the disclosure now turns to a further discussion of models that can be used through the environments and techniques described herein. Specifically, FIG. 19 is an illustrative example of a deep learning neural network 1900 that can be used to implement all or a portion of a perception module (or perception system) as discussed above. An input layer 1902 can be configured to receive sensor data and/or data relating to an environment surrounding an AV. The neural network 1900 includes multiple hidden layers 1904a, 1904b, through 1904c. The hidden layers 1904a through 1904c include “n” number of hidden layers, where “n” is an integer greater than or equal to one. The number of hidden layers can be made to include as many layers as needed for the given application. The neural network 1900 further includes an output layer 1906 that provides an output resulting from the processing performed by the hidden layers 1904a through 1904c. In one illustrative example, the output layer 1906 can provide estimated treatment parameters, that can be used/ingested by a differential simulator to estimate a patient treatment outcome.

The neural network 1900 is a multi-layer neural network of interconnected nodes. Each node can represent a piece of information. Information associated with the nodes is shared among the different layers and each layer retains information as information is processed. In some cases, the neural network 1900 can include a feed-forward network, in which case there are no feedback connections where outputs of the network are fed back into itself. In some cases, the neural network 1900 can include a recurrent neural network, which can have loops that allow information to be carried across nodes while reading in input.

Information can be exchanged between nodes through node-to-node interconnections between the various layers. Nodes of the input layer 1902 can activate a set of nodes in the first hidden layer 1904a. For example, as shown, each of the input nodes of the input layer 1902 is connected to each of the nodes of the first hidden layer 1904a. The nodes of the first hidden layer 1904a can transform the information of each input node by applying activation functions to the input node information. The information derived from the transformation can then be passed to and can activate the nodes of the next hidden layer 1904b, which can perform their own designated functions. Example functions include convolutional, up-sampling, data transformation, and/or any other suitable functions. The output of the hidden layer 1904b can then activate nodes of the next hidden layer, and so on. The output of the last hidden layer 1904c can activate one or more nodes of the output layer 1906, at which an output is provided. In some cases, while nodes in the neural network 1900 are shown as having multiple output lines, a node can have a single output and all lines shown as being output from a node represent the same output value.

In some cases, each node or interconnection between nodes can have a weight that is a set of parameters derived from the training of the neural network 1900. Once the neural network 1900 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1900 to be adaptive to inputs and able to learn as more and more data is processed.

The neural network 1900 is pre-trained to process the features from the data in the input layer 1902 using the different hidden layers 1904a through 1904c in order to provide the output through the output layer 1906.

In some cases, the neural network 1900 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1900 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1900 can perform a backward pass by determining which inputs (weights) most contributed to the loss of the network, and can adjust the weights so that the loss decreases and is eventually minimized.

The neural network 1900 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1900 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 20 illustrates an example lifecycle 2000 of a ML model in accordance with some examples. The first stage of the lifecycle 2000 of a ML model is a data ingestion service 2002 to generate datasets described below. ML models require a significant amount of data for the various processes described in FIG. 20 and the data persisted without undertaking any transformation to have an immutable record of the original dataset. The data can be provided from third party sources such as publicly available dedicated datasets. The data ingestion service 2002 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 2002 retrieves the data. In some examples, the data ingestion service 2002 may be online and the data is streamed from the producer in real-time for storage in the data ingestion service 2002.

After data ingestion service 2002, a data preprocessing service preprocesses the data to prepare the data for use in the lifecycle 2000 and includes at least data cleaning, data transformation, and data selection operations. The data cleaning and annotation service 2004 removes irrelevant data (data cleaning) and general preprocessing to transform the data into a usable form. The data cleaning and annotation service 2004 includes labelling of features relevant to the ML model. In some examples, the data cleaning and annotation service 2004 may be a semi-supervised process performed by a ML to clean and annotate data that is complemented with manual operations such as labeling of error scenarios, identification of untrained features, etc.

After the data cleaning and annotation service 2004, data segregation service 2006 to separate data into at least a training set 2008, a validation dataset 2010, and a test dataset 2012. Each of the training set 2008, a validation dataset 2010, and a test dataset 2012 are distinct and do not include any common data to ensure that evaluation of the ML model is isolated from the training of the ML model.

The training set 2008 is provided to a model training service 2014 that uses a supervisor to perform the training, or the initial fitting of parameters (e.g., weights of connections between neurons in artificial neural networks) of the ML model. The model training service 2014 trains the ML model based a gradient descent or stochastic gradient descent to fit the ML model based on an input vector (or scalar) and a corresponding output vector (or scalar).

After training, the ML model is evaluated at a model evaluation service 2016 using data from the validation dataset 2010 and different evaluators to tune the hyperparameters of the ML model. The predictive performance of the ML model is evaluated based on predictions on the validation dataset 2010 and iteratively tunes the hyperparameters based on the different evaluators until a best fit for the ML model is identified. After the best fit is identified, the test dataset 2012, or holdout data set, is used as a final check to perform an unbiased measurement on the performance of the final ML model by the model evaluation service 2016. In some cases, the final dataset that is used for the final unbiased measurement can be referred to as the validation dataset and the dataset used for hyperparameter tuning can be referred to as the test dataset.

After the ML model has been evaluated by the model evaluation service 2016, an ML model deployment service 2018 can deploy the ML model into an application or a suitable device. The deployment can be into a further test environment such as a simulation environment, or into another controlled environment to further test the ML model.

After deployment by the ML model deployment service 2018, a performance monitor service 2020 monitors for performance of the ML model. In some cases, the performance monitor service 2020 can also record additional transaction data that can be ingested via the data ingestion service 2002 to provide further data, additional scenarios, and further enhance the training of ML models.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Aspects:

The present technology includes computer-readable storage mediums for storing instructions, and systems for executing any one of the methods embodied in the instructions addressed in the aspects of the present technology presented below:

Aspect 1. A method comprising: presenting, in a prompt-guiding interface, a graphical representation of at least one suggested prompt concept, the at least one suggested prompt concept is for inclusion in a prompt to generate visual media content; receiving, by the prompt-guiding interface of a visual-media generation application, a selection of the at least one suggested prompt concept to yield a selected prompt concept; providing, by the visual-media generation application, the prompt to generate the visual media content to a media-generation service, the prompt is made of up one or more of the selected prompt concepts; and receiving, by the visual-media generation application, at least one preview of the visual media content that was generated by the media-generation service based on the prompt to generate the visual media content.

Aspect 2. The method of Aspect 1, further comprising: prior to the presenting the graphical representation of the at least one suggested prompt concept, requesting the at least one suggested prompt concept by the visual-media generation application from a suggested prompt concept service; obtaining the at least one suggested prompt concept and associated detailed prompt segments from the suggested prompt concept service for presentation of the at least one suggested prompt concept in the prompt-guiding interface; and displaying the suggested prompt concepts in a graphical user interface of the visual-media generation application for selection to aid a user in generating the prompt from the detailed prompt segments to generate visual media content.

Aspect 3. The method of any one of Aspects 1-2, further comprising: after the selection of the at least one suggested prompt concept, iteratively sending requests for revised suggested prompt concepts to the suggested prompt concept service.

Aspect 4. The method of any one of Aspects 1-3, further comprising: receiving a deselection of the at least one suggested prompt concept; and after the deselection of the at least one suggested prompt concept, iteratively sending requests for revised suggested prompt concepts to the suggested prompt concept service.

Aspect 5. The method of any one of Aspects 1-4, further comprising: translating, by the visual-media generation application, the at least one suggested prompt concept into a detailed prompt segment wherein the detailed prompt segment is sent to the media-generation service as the prompt to generate the visual media content.

Aspect 6. The method of any one of Aspects 1-5, further comprising: receiving, by the prompt-guiding interface, text input separate from the graphical representation of the at least one suggested prompt concept, the text input is descriptive of an aspect of the visual media content to be generated, the text input is included in the prompt to generate the visual media content.

Aspect 7. The method of any one of Aspects 1-6, wherein the detailed prompt segment is mapped to a specific text string, the detailed prompt segment includes text that expands the at least one suggested prompt concept with specific detail and context pertaining to the suggested prompt concept.

Aspect 8. The method of any one of Aspects 1-7, further comprising: receiving, a selection of the at least one preview of the visual media content, wherein the at least one preview of the visual media content is a generated thumbnail image; and processing the at least one preview of the visual media content into the visual media content, wherein the visual media content is a higher-resolution image and larger format version of the higher-resolution image created by upsampling the generated thumbnail image.

Aspect 9. The method of any one of Aspects 1-8, the at least one preview of the visual media content is a series of generated thumbnail images representing a video, and the visual media content is a video created that includes the generated thumbnail images, the video created is also in a higher resolution and larger format.

Aspect 10. The method of any one of Aspects 1-9, further comprising: presenting the at least one suggested prompt concept as a bubble in the prompt-guiding interface after receiving the selection of the at least one suggested prompt concept.

Aspect 11. The method of any one of Aspects 1-10, wherein the prompt-guiding interface can receive multiple selections of suggested prompt concepts, and the selections of the suggested prompt concepts are presented as bubbles in the prompt-guiding interface, the bubbles representing the selections of the suggested prompt concepts represent portions of the prompt to generate the visual media content.

Aspect 12. The method of any one of Aspects 1-11, further comprising: receiving, by the prompt-guiding interface, a photo as a portion of the prompt to generate the visual media content, wherein the photo is of a person or animal, wherein other portions of the prompt to generate the visual media content are intended to cause the media-generation service to modify an aspect of the photo.

Aspect 13. The method of any one of Aspects 1-12, further comprising: inputting the at least one preview of the visual media content into a safety-review-ML-model, wherein the safety-review-ML-model is configured to determine whether the at least one preview of the visual media content violates a content policy; and suppressing the at least one preview of the visual media content when the at least one preview of the visual media content is determined to violate the content policy.

Aspect 14. The method of any one of Aspects 1-13, further comprising: receiving a request for suggested prompt concepts, obtaining by a suggested prompt concept service suggested prompt concepts and associated detailed prompt segments; and sending the suggested prompt concepts and the associated detailed prompt segments to a visual-media generation application that requested the suggested prompt concepts.

Aspect 15. The method of any one of Aspects 1-14, wherein the request for the suggested prompt concepts also includes a request for a prompt-guiding interface to display the suggested prompt concepts, and sending a link to an instance of the prompt-guiding interface in response to the request.

Aspect 16. The method of any one of Aspects 1-15, wherein the prompt-guiding interface makes further requests to the suggested prompt concept service on behalf of the visual-media generation application.

Aspect 17. The method of any one of Aspects 1-16, wherein at least a portion of the suggested prompt concepts are images of entities represented in a photo library for a user account.

Aspect 18. The method of any one of Aspects 1-17, wherein the instructions further configure the at least one processor to: requesting, by the suggested prompt concept service and from the photo library, representative images of the entities represented in the photo library for the user account; and sending the representative images of the entities represented in the photo library as the portion of the suggested prompt concepts.

Aspect 19. The method of any one of Aspects 1-18 including training a diffusion model by: during a fine-tuning phase, training the diffusion model on a collection of portraits occupying a majority of a frame, wherein the diffusion model is configured to execute in an on-device environment; after receiving a prompt referencing a person, generating, by the diffusion model that was fine-tuned on the collection of portraits occupying the majority of the frame, at least one thumbnail image including a person in a scene.

Aspect 20. The method of any one of Aspects 1-19, wherein the generated thumbnail image has a resolution of less than 500 pixels in a vertical or horizontal dimension.

Aspect 21. The method of any one of Aspects 1-20, wherein the prompt referencing the person is subject to certain constraints.

Aspect 22. The method of any one of Aspects 1-21, further comprising: during human-feedback, reinforcement learning phase, generating synthetic prompts using a content generation engine to cause the diffusion model to generate images in response to respective prompts; comparing the images in response to the respective prompts from the diffusion model with second images in response to the respective prompts from a second model, wherein the second model is characterized by having a greater number of trainable parameters than the diffusion model; and receiving human feedback based on a comparison of the images with the second images, wherein the human feedback causes the diffusion model to improve for its objective.

Aspect 23. The method of any one of Aspects 1-22, further comprising: filtering a dataset of candidate images for images meeting aesthetic criteria and safety criteria to yield a filtered dataset of candidate images; generating respective detailed captions for images in the filtered dataset of candidate images by a caption generation model; receiving a curated dataset of manually captioned images representative of at least two categories, wherein the curated dataset includes a deliberate distribution of images across the at least two categories; during a model training phase, providing the diffusion model with the respective detailed captions and the filtered dataset of candidate images and the curated dataset to learn associations between captions and content of images.

Aspect 24. The method of any one of Aspects 1-23, further comprising: receiving by an image encoder/decoder, during an inference phase, a prompt image; encoding the prompt image for input into the diffusion model.

Aspect 25. The method of any one of Aspects 1-24, wherein the image encoder/decoder is resolution independent.

Aspect 26. The method of any one of Aspects 1-25, further comprising: receiving, in a first application, a prompt image and a text prompt and a style; encoding, by an image encoder/decoder, the prompt image for input into the diffusion model; encoding, by a text encoder the text prompt and style for input into the diffusion model; receiving, by the diffusion model an output of the text encoder and the image encoder/decoder; invoking a style adaptor by the diffusion model, based on the output of the text encoder, wherein the style adaptor corresponds to the style; outputting a latent representation of a generated thumbnail image into a decoder; converting the latent representation of the generated thumbnail image into the generated thumbnail image.

Aspect 27. The method of any one of Aspects 1-26, further comprising: analyzing the generated thumbnail image by a safety model that is configured to determine if the generated thumbnail image complies or violates safety criteria.

Aspect 28. The method of any one of Aspects 1-27, further comprising: managing memory of a computing device by bringing the image encoder/decoder, the text encoder, the style adaptor, the diffusion model into memory to perform a respective function, and then removing the image encoder/decoder, the text encoder, the style adaptor, the diffusion model from memory after the respective function has been performed.

Aspect 29. A method comprising: requesting suggested prompt concepts by a visual-media generation application from a suggested prompt concept service; obtaining the suggested prompt concepts and associated detailed prompt segments from the suggested prompt concept service; and displaying the suggested prompt concepts in a graphical user interface of the visual-media generation application for selection to aid a user in generating a prompt from the detailed prompt segments to generate visual media content.

Aspect 30. The method of Aspect 29, further comprising: requesting visual media content from a media-generation service to obtain visual media content created using the suggested prompt concepts that were selected.

Aspect 31. The method of any one of Aspects 29-30, further comprising: receiving a selection of at least one of the suggested prompt concepts; iteratively sending requests for revised suggested prompt concepts to the suggested prompt concept service, wherein the requests for revised suggested prompt concepts are made after the selection or a deselection of a particular suggested prompt concept, the request for revised suggested prompt concepts includes an identification of the prompt concepts that were selected.

Aspect 32. The method of any one of Aspects 29-31, further comprising: receiving a selection of at least one of the suggested prompt concepts; iteratively sending requests for visual media content to the media-generation service, wherein the requests for revised visual media content are made after the selection or a deselection of a particular suggested prompt concept, the request for visual media content includes prompts based on the prompt concepts that were selected.

Aspect 33. The method of any one of Aspects 29-32, wherein the request for the suggested prompt concepts includes a text string descriptive of a desired prompt concept, and the suggested prompt concepts obtained from the suggested prompt concept service are relevant to the text string.

Aspect 34. A method comprising: sending, by a visual-media generation application, a request for visual media content to a media-generation service, the request for the visual media content including a prompt to be used in generation of the visual media content; receiving, by the visual-media generation application, the visual media content generated by the media-generation service based on the prompt.

Aspect 35. The method of Aspect 34, further comprising: guiding, by the visual-media generation application, a user towards generation of the prompt using suggested prompt concepts.

Aspect 36. The method of any one of Aspects 34-35, further comprising: prior to sending the request for the visual media content, determining that the prompt meets safety criteria.

Aspect 37. A method comprising: receiving, by a media-generation service, a prompt in a request to generate visual media content based on the prompt, the request received from a visual-media generation application; generating, by the media-generation service, the visual media content based on the prompt; and sending the visual media content to the visual-media generation application.

Aspect 38. The method of Aspect 37, wherein the request to generate the visual media content identifies a style in which to generate the visual media content.

Aspect 39. The method of any one of Aspects 37-38, further comprising: prior to the generating the visual media content, evaluating the prompt to determine whether the prompt meets safety criteria; generating the visual media content when the prompt meets the safety criteria, else returning an error message.

Aspect 40. The method of any one of Aspects 37-39, further comprising: evaluating the visual media content generated by the media-generation service against safety criteria; generating a second version of the visual media content when the visual media content does not meet the safety criteria; and performing the sending of the second version of the visual media content when the visual media content meets the safety criteria.

Aspect 41. The method of any one of Aspects 37-40, wherein the generating the visual media content based on the prompt includes generating at least one thumbnail image and sending the at least one thumbnail image to the visual-media generation application.

Aspect 42. The method of any one of Aspects 37-41, further comprising: receiving a request to generate a higher-resolution image from the at least one thumbnail image; generating the higher-resolution image; and sending the higher-resolution image to the visual-media generation application.

Aspect 43. A computing system comprising: at least one processor; and a memory storing instructions that, when executed by the at least one processor, configure the computing system to perform the method recited in any one of aspects 1-42.

What is claimed is:

1. A method comprising:
presenting, in a prompt-guiding interface, a graphical representation of at least one suggested prompt concept, the at least one suggested prompt concept is for inclusion in a prompt to generate visual media content;
receiving, by the prompt-guiding interface of a visual-media generation application, a selection of the at least one suggested prompt concept to yield a selected prompt concept;
providing, by the visual-media generation application, the prompt to generate the visual media content to a media-generation service, the prompt is made of up one or more of the selected prompt concepts;
receiving, by the visual-media generation application, at least one preview of the visual media content that was generated by the media-generation service based on the prompt to generate the visual media content.

2. The method of claim 1, further comprising:
prior to the presenting the graphical representation of the at least one suggested prompt concept, requesting the at least one suggested prompt concept by the visual-media generation application from a suggested prompt concept service;
obtaining the at least one suggested prompt concept and associated detailed prompt segments from the suggested prompt concept service for presentation of the at least one suggested prompt concept in the prompt-guiding interface
displaying the suggested prompt concepts in a graphical user interface of the visual-media generation application for selection to aid a user in generating a prompt from the detailed prompt segments to generate visual media content.

3. The method of claim 2, further comprising:
after the selection of the at least one suggested prompt concept, iteratively sending requests for revised suggested prompt concepts to the suggested prompt concept service.

4. The method of claim 2, further comprising:
receiving a deselection of the at least one suggested prompt concept;
after the deselection of the at least one suggested prompt concept, iteratively sending requests for revised suggested prompt concepts to the suggested prompt concept service.

5. The method of claim 1, further comprising:
translating, by the visual-media generation application, the at least one suggested prompt concept into a detailed prompt segment wherein the detailed prompt segment is sent to the media-generation service as the prompt to generate the visual media content.

6. The method of claim 5, further comprising:
receiving, by the prompt-guiding interface, text input separate from the graphical representation of the at least one suggested prompt concept, the text input is descriptive of an aspect of the visual media content to be generated, the text input is included in the prompt to generate the visual media content.

7. The method of claim 5, wherein the detailed prompt segment is mapped to a specific text string, the detailed prompt segment includes text that expands the at least one suggested prompt concept with specific detail and context pertaining to the suggested prompt concept.

8. The method of claim 1, further comprising:
receiving, a selection of the at least one preview of the visual media content, wherein the at least one preview of the visual media content is a generated thumbnail image; and
processing the at least one preview of the visual media content into the visual media content, wherein the visual media content is a higher-resolution image and larger format version of the higher-resolution image created by upsampling the generated thumbnail image.

9. The method of claim 1, the at least one preview of the visual media content is a series of generated thumbnail images representing a video, and the visual media content is a video created that includes the generated thumbnail images, the video created is also in a higher resolution and larger format.

10. The method of claim 1, further comprising:
presenting the at least one suggested prompt concept as a bubble in the prompt-guiding interface after receiving the selection of the at least one suggested prompt concept.

11. The method of claim 10, wherein the prompt-guiding interface can receive multiple selections of suggested prompt concepts, and the selections of the suggested prompt concepts are presented as bubbles in the prompt-guiding interface, the bubbles representing the selections of the suggested prompt concepts represent portions of the prompt to generate the visual media content.

12. The method of claim 1, further comprising:
inputting the at least one preview of the visual media content into a safety-review-ML-model, wherein the safety-review-ML-model is configured to determine whether the at least one preview of the visual media content violates a content policy;
suppressing the at least one preview of the visual media content when the at least one preview of the visual media content is determined to violate the content policy.

13. A computing system comprising:
at least one processor; and
a memory storing instructions that, when executed by the at least one processor, configure the computing system to:
present, in a prompt-guiding interface, a graphical representation of at least one suggested prompt concept, the at least one suggested prompt concept is for inclusion in a prompt to generate visual media content;
receive, by the prompt-guiding interface of a visual-media generation application, a selection of the at least one suggested prompt concept to yield a selected prompt concept;
provide, by the visual-media generation application, the prompt to generate the visual media content to a media-generation service;
receive, by the visual-media generation application, at least one preview of the visual media content that was generated by the media-generation service based on the prompt to generate the visual media content.

14. The computing system of claim 13, wherein the instructions further configure the computing system to:
translate, by the visual-media generation application, the at least one suggested prompt concept into a detailed prompt segment wherein the detailed prompt segment is sent to the media-generation service as the prompt to generate the visual media content, wherein the detailed prompt segment is mapped to a specific text string, the detailed prompt segment includes text that expands the suggested prompt concept with specific detail and context pertain to the suggested prompt concept.

15. The computing system of claim 13, wherein the instructions further configure the computing system to:
receive, by the prompt-guiding interface, a photo as a portion of the prompt to generate the visual media content, wherein the photo is of a person or animal, wherein other portions of the prompt to generate the visual media content are intended to cause the media-generation service to modify an aspect of the photo.

16. A non-transitory computer-readable storage medium comprising instructions that when executed by at least one processor, cause the at least one processor to:
in response to receiving a request for suggested prompt concepts, obtaining by a suggested prompt concept service suggested prompt concepts and associated detailed prompt segments;
sending the suggested prompt concepts and the associated detailed prompt segments to a visual-media generation application that requested the suggested prompt concepts.

17. The non-transitory computer-readable storage medium of claim 16, wherein the request for the suggested prompt concepts also includes a request for a prompt-guiding interface to display the suggested prompt concepts, and sending a link to an instance of the prompt-guiding interface in response to the request.

18. The non-transitory computer-readable storage medium of claim 17, wherein the prompt-guiding interface makes further requests to the suggested prompt concept service on behalf of the visual-media generation application.

19. The non-transitory computer-readable storage medium of claim 16, wherein at least a portion of the suggested prompt concepts are images of entities represented in a photo library for a user account.

20. The non-transitory computer-readable storage medium of claim 19, wherein the instructions further configure the at least one processor to:
requesting, by the suggested prompt concept service and from the photo library, representative images of the entities represented in the photo library for the user account; and
sending the representative images of the entities represented in the photo library as the portion of the suggested prompt concepts.
